(19) United States
(12) Patent Application Publication
(10) Pub. No.: US 2026/0098181 A1
(43) Pub. Date: Apr. 9, 2026

(54) CROSSLINKABLE COATING SYSTEM AND COATINGS PREPARED FROM THE SAME

(71) Applicant: SWIMC LLC, Cleveland, OH (US)

(72) Inventors: Matthieu ANDRIOT, Attignat (FR); Benoit PROUVOST, Nantes (FR); Sébastien GIBANEL, Givry (FR); Philippe DELIGNY, Saint Nom La Breteche (FR); Mélissa MICHAELI, Tournus (FR); Adeline GEOFFROY, Sornay (FR)

(21) Appl. No.: 19/139,111

(22) PCT Filed: Dec. 15, 2023
(86) PCT No.: PCT/US2023/084303

§ 371 Date: Jun. 13, 2025

Related U.S. Application Data
(60) Provisional application No. 63/433,264, filed on Dec. 16, 2022.

(51) Int. Cl. C09D 133/14; C08F 220/14; C08F 220/34

(52) U.S. Cl. CPC C09D 133/14; C08F 220/14; C08F 220/343; C08F 2810/20

(57) ABSTRACT

Crosslinkable coating systems, methods of coating articles with the crosslinkable coating systems, and articles coated with the same are provided. The coating system includes a urea component and an aldehyde comprising two or more carbon atoms. The coating system may include a solvent. The coating system may be free or substantially free of fonnaldehyde and isocyanate. The coating system may include a reaction product of a urea component and an aldehyde comprising two or more carbon atoms. The coating system may be in powder form.

### SUMMARY

The present disclosure broadly relates to crosslinkable coating systems. The present disclosure further relates to methods of coating articles with the crosslinkable coating systems and to articles coated with the same.

In some embodiments, a coating system includes a urea component; an aldehyde comprising two or more carbon atoms; and a solvent. The urea component may be present at a molar ratio of 0.5 to 2.5 moles for every 1 mole of the aldehyde. The urea component may be represented by Formula (I):

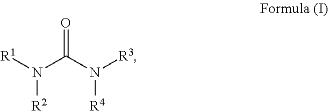

wherein R¹, R², R³, and R⁴ are independently H or a carbon-containing group, optionally further substituted with one or more oxygen, nitrogen, or sulfur atoms or a combination thereof, preferably where R¹, R², R³, and R⁴ are independently H or an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group,
wherein at least one of R¹, R², R³, and R⁴ is H, and
wherein any two of R¹, R², R³, and R⁴ may connect together to form a cyclic group.

The aldehyde may be represented by Formula (II) or (IIA):

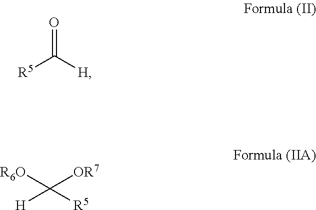

where R⁵ is a carbon-containing group, optionally further substituted with one or more oxygen, nitrogen, or sulfur atoms or a combination thereof, preferably where R⁵ is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, optionally wherein the aldehyde is in a protected form comprising an acetal or a hydrate. The aldehyde may be a monoaldehyde. The aldehyde may be a polyaldehyde. The aldehyde may be an oligomer. And where each R⁶ and R⁷ are independently carbon-containing groups, optionally further substituted with one or more oxygen, nitrogen, or sulfur atoms or a combination thereof, preferably where each R⁶ and R⁷ are independently an alkyl, aryl, acyl, acrylate, carboxylic acid, urethane, ester, amide, carbonate, alkenyl, alkynyl, alkoxy, alcohol, amine, methacrylate, acrylamide, methacrylamide, vinyl, phenol, ketone, alkylamine or urea group. Each R⁶ and R⁷ may independently be straight, branched, or cyclic, and may include zero, one, or more double bonds. Each R⁶ and R⁷ may independently include any suitable number of carbon atoms. In some embodiments, each R⁶ and R⁷ may independently be an oligomer or polymer. In preferred embodiments, R⁶ and R⁷ are independently a carbon-containing group with one to four carbon atoms. In some preferred embodiments, the R⁶ and R⁷ groups on the acetal of Formula (IIA) are such that R⁶═R⁷ In some embodiments. R⁶ and R⁷ may be bonded to form a cyclic acetal.

The urea component and the aldehyde may form a reaction product represented by Formula (III):

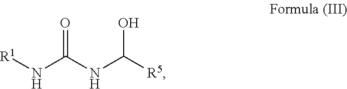

wherein R¹ is a carbon-containing group, optionally further substituted with one or more oxygen, nitrogen, or sulfur atoms or a combination thereof, preferably where R¹ is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, and R⁵ is as in Formula (II).

The urea component and the aldehyde may form a further reaction product represented by Formula (IV):

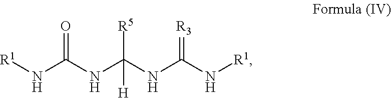

wherein R¹ is a carbon-containing group, optionally further substituted with one or more oxygen, nitrogen, or sulfur atoms or a combination thereof, preferably where R¹ is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, and R⁵ is as in Formula (II).

The coating system may be free or substantially free of formaldehyde. The coating system may be free or substantially free of isocyanate.

The coating system may be curable at a temperature of 60° C. or lower, 50° C. or lower, 40° C. or lower, 30° C. or lower, or 25° C. or lower.

In some embodiments, a coating system includes a reaction product of: a urea component; and an aldehyde comprising two or more carbon atoms.

The reaction product may be a crosslinked product of Formula (III):

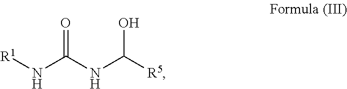

wherein R¹ is a carbon-containing group, optionally further substituted with one or more oxygen, nitrogen, or sulfur atoms or a combination thereof, preferably where R¹ is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, and R⁵ is as in Formula (II).

The reaction product may be a crosslinked product of Formula (IV):

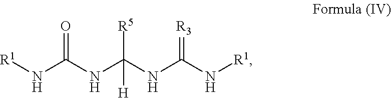

wherein R¹ is a carbon-containing group, optionally further substituted with one or more oxygen, nitrogen, or sulfur atoms or a combination thereof, preferably where R¹ is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, and R⁵ is as in Formula (II).

The coating system may be in powder form.

The coating system may include an organic solvent, water, or both.

The coating system may be free or substantially free of formaldehyde and structural units derived from formaldehyde. The coating system may be free or substantially free of isocyanate and structural units derived from isocyanate.

The present disclosure further provides articles coated with the coating system.

### BRIEF DESCRIPTION OF FIGURES

FIG. 1 is an NMR spectrum of the sample produced in Example 1 according to an embodiment.

FIG. 2 is an NMR spectrum of the sample produced in Example 3 according to an embodiment.

FIG. 3 is an NMR spectrum of the sample produced in Example 4 according to an embodiment.

FIG. 4 is an NMR spectrum of an intermediate product produced in Example 5 according to an embodiment.

FIG. 5 is an NMR spectrum of the final sample produced in Example 6 according to an embodiment.

FIG. 6 is an NMR spectrum of the sample produced in Example 7 according to an embodiment.

FIG. 7 is an NMR spectrum of the sample produced in Example 8 according to an embodiment.

FIG. 8 is an NMR spectrum of the sample produced in Example 9 according to an embodiment.

FIG. 9 is an NMR spectrum of an intermediate product produced in Example 10 according to an embodiment.

FIG. 10 is an NMR spectrum of the final sample produced in Example 12 according to an embodiment.

FIG. 11 is an NMR spectrum of the sample produced in Example 13 according to an embodiment.

FIG. 12 is an NMR spectrum of the sample produced in Example 15 according to an embodiment.

FIG. 13 is an NMR spectrum of the sample produced in Example 24 according to an embodiment.

### DEFINITIONS

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, the terms “polymer” and “polymeric material” include, but are not limited to, organic homopolymers, copolymers, such as for example, block, graft, random and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic, and atactic symmetries.

The term “aromatic ring” is used in this disclosure to refer to a conjugated ring system of an organic compound. Aromatic rings may include carbon atoms only, or may include one or more heteroatoms, such as oxygen, nitrogen, or sulfur.

The term “alkylated” is used in this disclosure to describe compounds that are reacted to replace a hydrogen atom or a negative charge of the compound with an alkyl group, such that the alkyl group is covalently bonded to the compound.

The term “alkyl” is used in this disclosure to describe a monovalent group that is a radical of an alkane and includes straight-chain, branched, cyclic, and bicyclic alkyl groups, and combinations thereof, including both unsubstituted and substituted alkyl groups. Unless otherwise indicated, the alkyl groups typically contain from 1 to 30 carbon atoms. In some embodiments, the alkyl groups contain 1 to 20 carbon atoms, 1 to 10 carbon atoms, 1 to 6 carbon atoms, 1 to 4 carbon atoms, or 1 to 3 carbon atoms. Examples of alkyl groups include, but are not limited to, methyl, ethyl, n-propyl, n-butyl, n-pentyl, isobutyl, t-butyl, isopropyl, n-octyl, n-heptyl, ethylhexyl, cyclopentyl, cyclohexyl, cycloheptyl, etc.

The term “crosslinker” refers to a molecule capable of forming a covalent linkage between separate polymers or between two different regions of the same polymer.

The term “group” is intended to be a recitation of both the particular moiety, as well as a recitation of the broader class of substituted and unsubstituted structures that includes the moiety. Thus, when the term “group” is used to describe a chemical substituent, the described chemical material includes the unsubstituted group (e.g., the moiety) and that group with O, N, Si, or S atoms, for example, in the chain (as in an alkoxy group) as well as carbonyl groups or other conventional substitution. Where the term “moiety” is used to describe a chemical compound or substituent, only an unsubstituted chemical material is intended to be included. For example, the phrase “alkyl group” is intended to include not only pure open chain saturated hydrocarbon alkyl substituents, such as methyl, ethyl, isopropyl, t-butyl, heptyl, dodecyl, octadecyl, amyl, 2-ethylhexyl, and the like, but also alkyl substituents bearing further substituents known in the art, such as hydroxy, alkoxy, alkylsulfonyl, halogen atoms, cyano, nitro, amino, carboxyl, etc. Thus, “alkyl group” includes ether groups, haloalkyls, nitroalkyls, carboxyalkyls, hydroxyalkyls, sulfoalkyls, etc. On the other hand, the phrase “alkyl moiety” is limited to the inclusion of only pure open chain saturated hydrocarbon alkyl substituents, such as methyl, ethyl, isopropyl, t-butyl, heptyl, dodecyl, octadecyl, amyl, 2-ethylhexyl, and the like.

The term “substantially” as used here has the same meaning as “significantly,” and can be understood to modify the term that follows by at least about 90%, at least about 95%, or at least about 98%. The term “substantially free” of a particular compound means that the compositions of the present invention contain less than 1,000 parts per million (ppm) of the recited compound. The term “essentially free” of a particular compound means that the compositions of the present invention contain less than 100 parts per million (ppm) of the recited compound. The term “completely free” of a particular compound means that the compositions of the present invention contain less than 20 parts per billion (ppb) of the recited compound. In the context of the aforementioned phrases, the compositions of the present invention contain less than the aforementioned amount of the compound whether the compound itself is present in unreacted form or has been reacted with one or more other materials.

The term “not substantially” as used here has the same meaning as “not significantly,” and can be understood to have the inverse meaning of “substantially,” i.e., modifying the term that follows by not more than 25%, not more than 10%, not more than 5%, or not more than 2%.

The term “about” is used here in conjunction with numeric values to include normal variations in measurements as expected by persons skilled in the art, and is understood to have the same meaning as “approximately” and to cover a typical margin of error, such as +5% of the stated value.

Terms such as “a,” “an,” and “the” are not intended to refer to only a singular entity, but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

The recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” or “at least” a particular value, that value is included within the range.

As used here, “have.” “having.” “include.” “including.” “comprise,” “comprising,” or the like are used in their open-ended sense, and generally mean “including, but not limited to.” It will be understood that “consisting essentially of,” “consisting of,” and the like are subsumed in “comprising” and the like. As used herein, “consisting essentially of,” as it relates to a composition, product, method, or the like, means that the components of the composition, product, method, or the like are limited to the enumerated components and any other components that do not materially affect the basic and novel characteristic(s) of the composition, product, method, or the like.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure, including the claims.

Any direction referred to here, such as “top,” “bottom,” “left,” “right,” “upper,” “lower,” and other directions and orientations are described herein for clarity in reference to the figures and are not to be limiting of an actual device or system or use of the device or system. Devices or systems as described herein may be used in a number of directions and orientations.

### DETAILED DESCRIPTION

The present disclosure broadly relates to crosslinkable coating systems. The present disclosure further relates to methods of coating articles with the crosslinkable coating systems and to articles coated with the same.

A wide variety of coatings have been used to coat the surfaces of articles, structures, packaging, etc. For example, protective and/or decorative coatings may be applied to wood, wood products, metals, polymers, packaging materials, etc. With regard to coatings in general, there is a desire to use coating systems that are free of isocyanates and formaldehyde. Further, there is a need for finding alternative crosslinking chemical processes and methodologies to systems that include isocyanates or formaldehyde. In particular, there is a need for finding alternative crosslinking chemical processes and methodologies for two-part coating systems that typically include isocyanate, and for one-part coating systems that typically include formaldehyde.

The coating systems of the present disclosure may be used for many purposes and to coat various materials. The coating systems are suitable for use as coatings for wood, wood products, metals, polymers, packaging materials, etc. The coating systems may be used to coat, for example, structural features, architectural elements, articles, containers, packaging, etc. All such items are collectively referred to here as “articles.” The present disclosure provides methods of coating articles with the coating composition and articles coated with the coating composition.

According to an embodiment, the crosslinkable coating systems are based on two reactive compounds, a urea component and an aldehyde, and optionally a catalyst, and further optionally an amine. The urea component may be an unsubstituted urea or a substituted urea. The urea component and aldehyde react to form a hemiaminal. The hemiaminal may further react with urea or another substituted urea to form aminal (aminoacetal). The hemiaminal and/or aminal may be used to form oligomers and polymers. The substituted urea may be mono-N-substituted, N,N-substituted, N,N′-substituted, or N,N,N′-substituted urea. The aldehyde may optionally be in a protected form, such as an acetal or a hydrate. In one embodiment, the crosslinkable coating system comprises a reaction product of urea and an aldehyde. In one embodiment, the crosslinkable coating system comprises a reaction product of mono-N-substituted urea and an aldehyde. In one embodiment, the crosslinkable coating system comprises a reaction product of N,N-substituted urea and an aldehyde. In one embodiment, the crosslinkable coating system comprises a reaction product of N,N′-substituted urea and an aldehyde. In one embodiment, the crosslinkable coating system comprises a reaction product of N,N,N′-substituted urea and an aldehyde. The crosslinkable coating system may also include reaction products of one or more different types of unsubstituted or substituted ureas and one or more different types of aldehydes.

The combination of the urea component (unsubstituted or substituted urea such as mono-N-substituted, N,N-substituted, N,N′-substituted, or N,N,N′-substituted urea) and aldehyde provides a crosslinkable coating composition that is free or substantially free of formaldehyde, isocyanate, or both. According to an embodiment, the crosslinkable coating composition is free or substantially free of both formaldehyde and isocyanate. Many prior art one-part compositions include formaldehyde. The crosslinkable coating composition of the present disclosure may be a one-part composition that is free or substantially free of formaldehyde. Many prior art two-part compositions include isocyanate. The crosslinkable coating composition of the present disclosure may be a two-part composition that is free or substantially free of isocyanate.

The coating composition may be used to prepare a polymeric coating that is free or substantially free of formaldehyde and structural units derived from formaldehyde. The coating composition may be used to prepare a polymeric coating that is free or substantially free of isocyanate and structural units derived from isocyanate. The coating composition may be used to prepare a polymeric coating that is free or substantially free of formaldehyde and structural units derived from formaldehyde and free or substantially free of isocyanate and structural units derived from isocyanate.

In some embodiments, the coating composition of the present disclosure may be a one-component system. or it may be a two-component system. In other words, the coating composition may be a one-part system or a two-part system. The coating composition being a one-part system refers to the ingredients of the coating system being in a pre-mixed form, i.e., the reagents are provided as a pre-mixed mixture. Such pre-mixed mixtures do not have to be mixed immediately prior to application of the coating on the article or surface being coated with the coating system. In embodiments where the coating composition is a one-part system, the reactivity of the reagents (unsubstituted or substituted urea, aldehyde, and optional catalyst) may be selected to keep the reaction from occurring too soon (e.g., prior to application of the coating composition). For example, the urea component and/or the aldehyde may be selected to have a higher or lower reactivity. Further, at least some of the functional groups of the reagents may be shielded using protective groups (for example, by forming acetal groups or hydrates on the aldehyde) that prevent the reaction from occurring until the protective group is removed.

The coating composition being a two-part coating system refers to the composition of the coating system not being in a pre-mixed form. It refers to the coating system being comprised of two mixtures of the reagents of the coating system. The reagents in the two mixtures are substantially unreactive until the two mixtures (or “two parts”) are combined together. Combining the two “parts” of a two-part coating system allows the reagents to react and form the coating.

### Urea Component

According to an embodiment, the crosslinkable coating systems of the present disclosure include a reaction product of a urea component and an aldehyde. The urea component may be unsubstituted or substituted. The substituted urea may be mono-N-substituted, N,N-substituted, N,N′-substituted, or N,N,N′-substituted urea.

According to an embodiment, the urea component is represented by Formula (I):

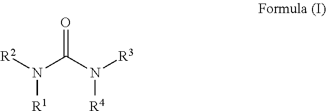

where R¹, R², R³, and R⁴ are independently H or a carbon-containing group, optionally further substituted with one or more oxygen, nitrogen, or sulfur atoms or a combination thereof, preferably where R¹, R², R³, and R⁴ are independently H or an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group. At least one of R¹, R², R³, and R⁴ is H. R¹, R², R³, and R⁴ may independently be straight, branched, or cyclic, and may include zero, one, or more double bonds. Any two of R¹, R², R³, and R⁴ may connect together to form a cyclic group. R¹, R², R³, and R⁴ may independently include any suitable number of carbon atoms. In some embodiments, R¹, R², R³, and R⁴ may independently be an oligomer or polymer.

According to an embodiment, the urea component is urea, represented by Formula (IA):

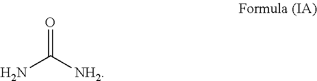

That is, each of R¹, R², R³, and R⁴ is H.

According to an embodiment, the urea component is monosubstituted N-substituted urea, referred to here as mono-N-substituted urea Mono-N-substituted urea may be represented by Formula (IB):

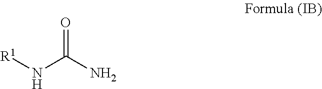

where R¹ is a carbon-containing group, optionally further substituted with one or more oxygen, nitrogen, or sulfur atoms or a combination thereof, preferably where R¹ is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group. R¹ may be straight, branched, or cyclic, and may include zero, one, or more double bonds. R¹ may include any suitable number of carbon atoms. In some embodiments, R¹ may be an oligomer or polymer.

In some embodiments, mono-N-substituted ureas may be obtained by any technique known in the art. For example, mono-N-substituted ureas may be obtained by oxidation of a primary amine by potassium cyanate:

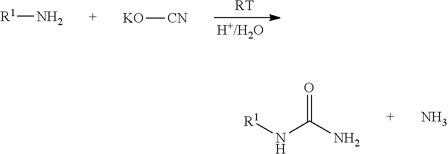

or by condensation of a primary amine with urea:

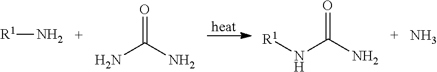

In some embodiments, mono-N-substituted ureas may be obtained by condensation of a primary amine with methyl carbamate:

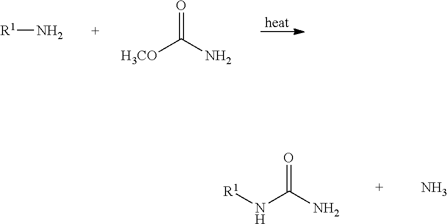

Some non-limiting relevant examples of amino or hydroxy functionalized mono-N-substituted ureas include 2-hydroxyethylurea, 2-aminoethylurea, and 1,1′-(iminodi-2,1-ethanediyl)diurea. Various amino or hydroxy functionalized mono-N-substituted ureas may be used to produce monomers. Some non-limiting relevant examples of such monomers utilized for radical polymerization include:

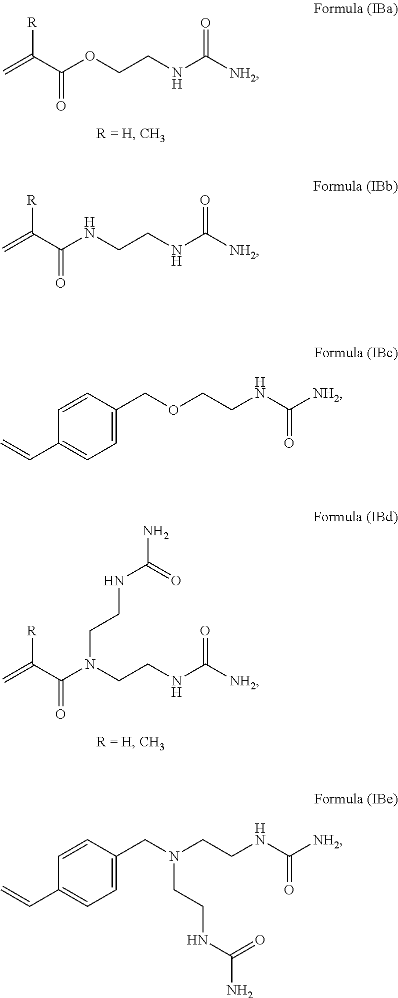

Some non-limiting relevant examples of monomers produced from amino or hydroxy functionalized mono-N-substituted ureas and utilized for polycondensation include

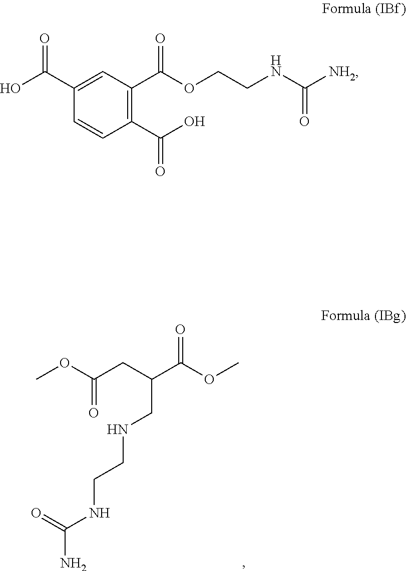

2-aminoethylurea and 1,1′-(iminodi-2, 1-ethanediyl)diurea could also be reacted by the aza-Michael addition with polyunsaturated molecules, such as poly (meth)acrylates to produced polyureas.

According to an embodiment, the urea component is N,N-substituted urea represented by Formula (IC):

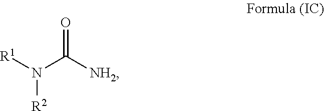

where R¹ and R² are independently carbon-containing groups, optionally further substituted with one or more oxygen, nitrogen, or sulfur atoms or a combination thereof, preferably where R¹ and R² are independently an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group. R¹ and R² may independently be straight, branched, or cyclic, and may include zero, one, or more double bonds. R¹ and R² may independently include any suitable number of carbon atoms. In some embodiments, R¹ and R² may independently be an oligomer or polymer.

N,N-substituted urea may be obtained, for example, by condensation of a secondary amine with urea:

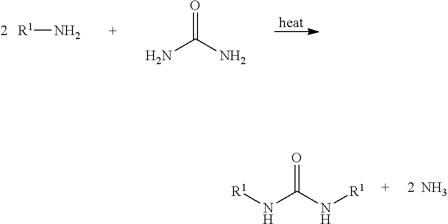

Some non-limiting relevant examples of hydroxy functionalized secondary amines used to produce N,N-substituted ureas include (2-hydroxyethyl)methylamine and diethanolamine. Diethanolamine may be utilized to produce 1,1-bis(2-hydroxyethyl) urea for polycondensation:

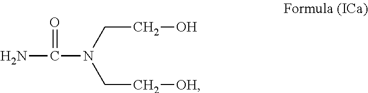

(2-Hydroxyethyl)methylamine may be utilized to produce molecules of the following structures for radical polymerization:

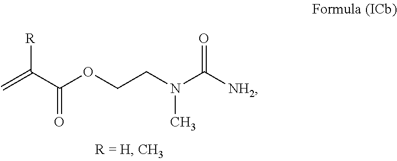

According to an embodiment, the urea component is N,N′-substituted urea represented by Formula (ID):

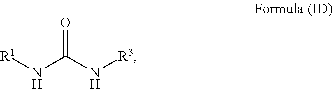

where R¹ and R³ are independently carbon-containing groups, optionally further substituted with one or more oxygen, nitrogen, or sulfur atoms or a combination thereof, preferably where R¹ and R³ are independently an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group. R¹ and R³ may independently be straight, branched, or cyclic, and may include zero, one, or more double bonds. R¹ and R³ may independently include any suitable number of carbon atoms. In some embodiments, R¹ and R³ may independently be an oligomer or polymer.

In some embodiments, N,N′-substituted ureas may be obtained, for example, by condensation of two primary amines with urea:

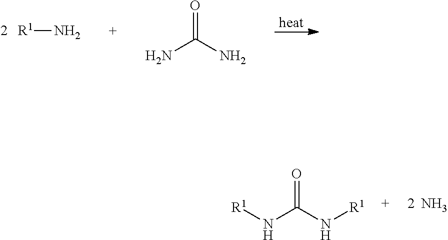

A non-limiting relevant example of N,N′-substituted urea includes 1,3-bis(2-hydroxyethyl)urea, which may be produced from urea and ethanolamine and used in polycondensation:

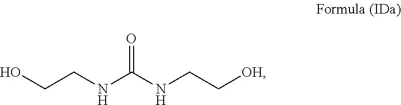

According to an embodiment, the urea component is N,N,N′-substituted urea represented by Formula (IE):

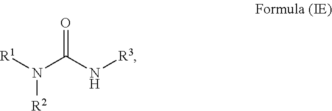

where R¹, R², and R³ are independently carbon-containing groups, optionally further substituted with one or more oxygen, nitrogen, or sulfur atoms or a combination thereof, preferably where R¹, R², and R³ are independently an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group. R¹, R², and R³ may independently be straight, branched, or cyclic, and may include zero, one, or more double bonds. R¹, R², and R³ may independently include any suitable number of carbon atoms. In some embodiments, R¹, R², and R³ may independently be an oligomer or polymer.

Exemplary cyclic urea components include the following:

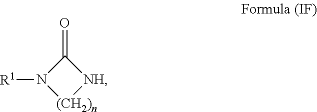

where R¹ is H or a carbon-containing group, optionally further substituted with one or more oxygen, nitrogen, or sulfur atoms or a combination thereof, preferably where R¹ is independently an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group. R¹ may be straight, branched, or cyclic, and may include zero, one, or more double bonds. R¹ may include any suitable number of carbon atoms. In some embodiments, R¹ may be an oligomer or polymer; and
where n is greater than 1, preferably where n is from 2, 3, 4, 5, or 6, more preferably where n is 2 or 3.

Some non-limiting relevant examples of cyclic N,N,N′-substituted urea are 1-(2-hydroxyethyl)-2-imidazolidinone and 1-(2-aminoethyl)-2-imidazolidinone. In some embodiments, such cyclic N,N,N′-substituted urea may be used to produced, for example, monomers for radical polymerization:

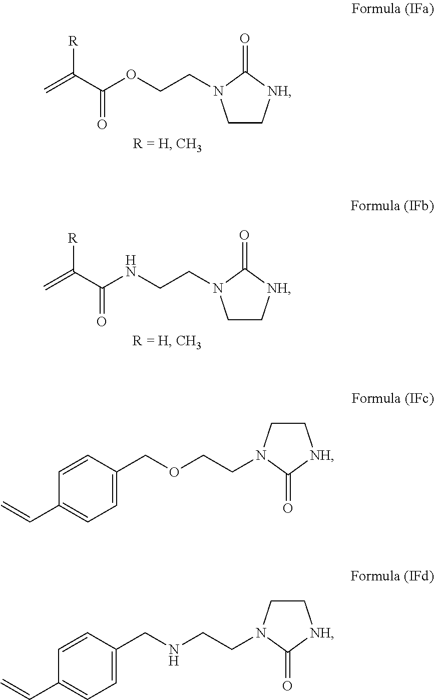

In some embodiments, 1-(2-aminoethyl)-2-imidazolidinone may be reacted with polyunsaturated molecules, such as poly (meth)acrylates to produced polyureas via aza-Michael addition.

Specific non-limiting relevant examples of the urea component include urea, 2-imidazolidone, glycoluril, 2-hydroxyethyl urea, methacryloxyethyl ethylene urea, biuret, allophanate, and methacrylamidoethyl ethylene urea.

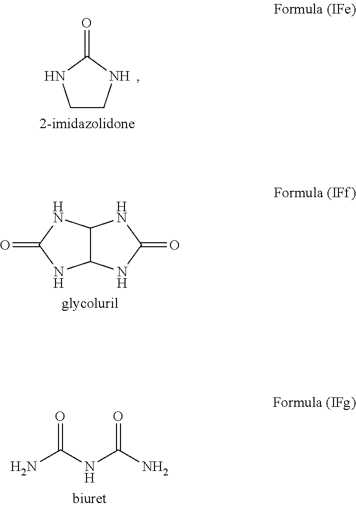 [SMILES: O=C1NCCN1 ; O=C1NC2NC(=O)NC2N1 ; NC(=O)NC(N)=O]

In some embodiments, Formula (I) is not a polyether. In some embodiments, Formula (I) does not include polyether.

In some embodiments, the urea compound is a di-N,N′-substituted urea represented by Formula (IG):

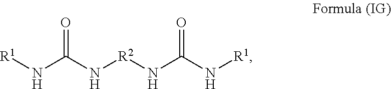

where each R¹ and R² are independently a carbon-containing group, optionally further substituted with one or more oxygen, nitrogen, or sulfur atoms or a combination thereof, preferably where each R¹ and R² are independently an alkyl, aryl, acyl, acrylate, carboxylic acid, urethane, ester, amide, carbonate, alkenyl, alkynyl, alkoxy, alcohol, amine, methacrylate, acrylamide, methacrylamide, vinyl, phenol, ketone, or alkylamine group. Each R¹ and R² may independently be straight, branched, or cyclic, and may include zero, one, or more double bonds. Each R¹ and R² may independently include any suitable number of carbon atoms. In some embodiments, each R¹ and R² may independently be an oligomer or polymer.

The urea component may be a triurea or polyurea, analogous to the diurea of Formula (IG). The urea component may further include branched urea-functionalities, such as in the structure of Formula (IF):

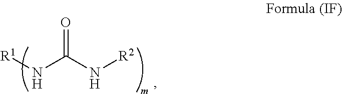

where m is 2, 3, or 4.

The amines utilized in the synthesis of the urea component may include diamines (e.g., N-tetramethyl-1,6-hexanediamine, 2-methylpentane-1,5-diamine, or the like), triamines (e.g., tris(2-aminoethyl)amine), or oligomeric amines (e.g., polyethylenimine in linear, branched, or dendrimer form).

The urea component may be diurea or triurea obtained by transurethanisation of methylcarbamate by diamine or triamine:

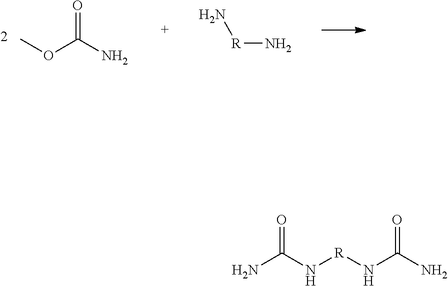

In some embodiments, the urea component may be an acrylic resin obtained by free radical polymerization of monomers containing the substituted urea group. A non-limiting relevant example of such an acrylic resin includes methacrylate N-hydroxyethyl urea obtained by transesterification of N-hydroxyethyl urea with methyl methacrylate, wherein the N-hydroxyethyl urea may be obtained by oxidation with potassium cyanate of ethanolamine. A non-limiting relevant example of such a monomer includes a N,N,N′-substituted cyclic urea methacryloxyethyl ethylene urea (Formula (IFa)), commercially available as UMA 25% (available from BASF in Florham Park, NJ), as WAM 250 (available from Solvay Chemicals, Inc. in Alorton, IL), or MEEU-50 W or MEEU-25 M (available from Evonik in Piscataway, NJ):

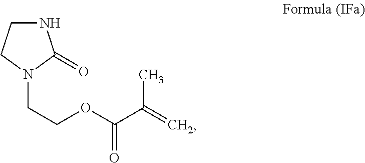

The urea component may be a polyester resin obtained by esterification or transesterification of monomers containing the substituted urea group. A non-limiting relevant example of such a monomer includes a N,N-substituted urea containing diol, which may be obtained by the reaction of deamination between urea and diethanolamine:

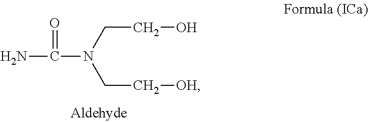

According to an embodiment, the crosslinkable coating systems of the present disclosure include a reaction product of a urea component and an aldehyde. The aldehyde may be a monoaldehyde, dialdehyde, trialdehyde, or polyaldehyde. The aldehyde may be an oligomer or a polymer. The aldehyde may optionally be in a protected form prior to reaction, such as an acetal or a hydrate. In some embodiments, the aldehyde is liquid at room temperature (about 20° C. to 25° C.). The aldehyde may also have low toxicity and acceptable smell.

In some embodiments, the aldehyde is a monoaldehyde. Some non-limiting relevant examples of suitable aldehydes include heptanal, octanal, cyclohexane carboxaldehyde, benzaldehyde, furfural, vanillin, hydroxymethyl furfural (HMF), pivaldehyde, hydroxypivaldehyde, and aliphatic aldehydes obtained by oxidative cleavage of double bonds, and the like. In some cases, the aldehyde may be biobased, that is obtained from non-petroleum-based sources.

The aldehyde may be represented by Formula (II):

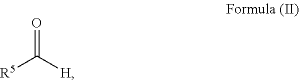

where R⁵ is a carbon-containing group, optionally further substituted with one or more oxygen, nitrogen, or sulfur atoms or a combination thereof, preferably where R⁵ is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group. In some embodiments, R⁵ may be straight, branched, or cyclic, and may include zero, one, or more double bonds. R⁵ may include any suitable number of carbon atoms. In some embodiments, R⁵ may be an oligomer or polymer.

In some embodiments, the aldehyde in the crosslinkable coating systems of the present disclosure is a polyaldehyde. In some embodiments, the polyaldehyde in the crosslinkable coating systems of the present disclosure is chosen from a group consisting of terephthaldehyde, glutaraldehyde, glyoxal, dimethoxy acetaldehyde, methylglyoxal, cyclohexanedicarbaldehyde, malondialdehyde bis(dimethyl acetal), 5,5′-(oxy-bis(methylene))bis-2-furfural, bis(dimethyl acetal) of imidazolidone, tetra-dimethyl acetal of glycoluryl, bis(dimethyl acetal) of polyglycidyl ether, tri (aminoethyl dimethyl acetal) of itaconic, tri (aminoethyl dimethyl acetal) of TMPEOTA, poly(dimethyl acetal) of polycyclocarbonate.

In some embodiments, the aldehyde is in a protected form as acetal. The acetal is obtained by the reaction of alcohols on the aldehyde and may be represented by Formula (IIA):

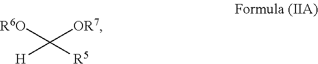

where R⁵ is a carbon-containing group, optionally further substituted with one or more oxygen, nitrogen, or sulfur atoms or a combination thereof, preferably where R⁵ is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group. In some embodiments, R⁵ may be straight, branched, or cyclic, and may include zero, one, or more double bonds. R⁵ may include any suitable number of carbon atoms. In some embodiments, R⁵ may be an oligomer or polymer. And where each R⁶ and R⁷ are independently carbon-containing groups, optionally further substituted with one or more oxygen, nitrogen, or sulfur atoms or a combination thereof, preferably where each R⁶ and R⁷ are independently an alkyl, aryl, acyl, acrylate, carboxylic acid, urethane, ester, amide, carbonate, alkenyl, alkynyl, alkoxy, alcohol, amine, methacrylate, acrylamide, methacrylamide, vinyl, phenol, ketone, alkylamine or urea group. Each R⁶ and R⁷ may independently be straight, branched, or cyclic, and may include zero, one, or more double bonds. Each R⁶ and R⁷ may independently include any suitable number of carbon atoms. In some embodiments, each R⁶ and R⁷ may independently be an oligomer or polymer. In preferred embodiments, R⁶ and R⁷ are independently a carbon-containing group with one to four carbon atoms.

In some preferred embodiments, the R⁶ and R⁷ groups on the acetal of Formula (IIA) are such that R⁶═R⁷. In some embodiments, R⁶ and R⁷ may be bonded to form a cyclic acetal.

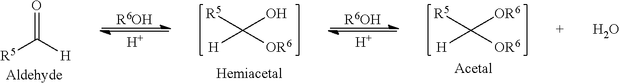

In some embodiments, the aldehyde is in a protected form as hydrate. The hydrate is obtained by the reaction of water on the aldehyde and may be represented by the formula:

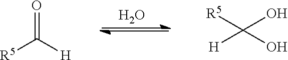

where R⁵ is a carbon-containing group, optionally further substituted with one or more oxygen, nitrogen, or sulfur atoms or a combination thereof, preferably where R⁵ is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group. In some embodiments, R⁵ may be straight, branched, or cyclic, and may include zero, one, or more double bonds. R⁵ may include any suitable number of carbon atoms. In some embodiments, R⁵ may be an oligomer or polymer.

In the following, the term aldehyde described an aldehyde or a hydrate or an acetal.

In some embodiments, the aldehyde is a polyaldehyde, such as terephthaldehyde, glutaraldehyde, glyoxal, dimethoxy acetaldehyde, methylglyoxal, cyclohexanedicarbaldehyde, and malondialdehyde bis(dimethyl acetal), 5,5-′ (oxy-bis(methylene))bis-2-furfural (Example 22), bis(dimethyl acetal) of imidazolidone (Example 14), tetra-dimethyl acetal of glycoluryl, bis(dimethyl acetal) of polyglycidyl ether (Example 12), tri (aminoethyl dimethyl acetal) of itaconic (Example 13), tri (aminoethyl dimethyl acetal) of TMPEOTA (Example 10), poly(dimethyl acetal) of polycyclocarbonate (Example 15).

In some embodiments, the aldehyde is an oligomer or a polymer. The oligomer or polymer aldehyde may include a plurality of aldehyde functional groups. For example, the aldehyde may be a dialdehyde obtained by condensation of a hydroxyaldehyde, such as 5,5′-[oxy-bis(methylene)]di(2-furaldehyde). The dialdehyde may be formed by crotonization with an enolizable ketone, such as cyclohexanone. In one example, a dialdehyde is formed from HMF and cyclohexanone. The ketone may be used at a ratio of HMF/cyclohexanone that is greater than 1. The aldehyde may be a dialdehyde obtained by coupling two hydroxyaldehydes by the use of a dicarbamate.

In some embodiments, the aldehyde is an acrylic (co) polymer, which may be obtained by free radical polymerization of a monomer mixture containing aldehyde-functional monomers. Such aldehyde-functional monomers may be obtained in various ways. For example, such aldehyde-functional monomers may be based on acrolein, acrolein diethyl acetal, N-methacrylamidoacetaldehyde dimethyl acetal (example 9) or 5-(hydroxymethyl) furfural methacrylate (HMF methacrylate, example 22) or 4-methacryloyloxy-3-methoxybenzaldehyde (vanillin methacrylate). Or the reaction product between aminoacetaldehyde dimethyl acetal (or (methylamino) acetaldehyde dimethyl acetal) and glycidyl ether methacrylate (GMA) or glycerol carbonate methacrylate (GCMA) or 4-(chloromethyl) styrene (CMS) or 3-acryloyloxy-2-hydroxypropyl methacrylate:
where R═H or CH₃

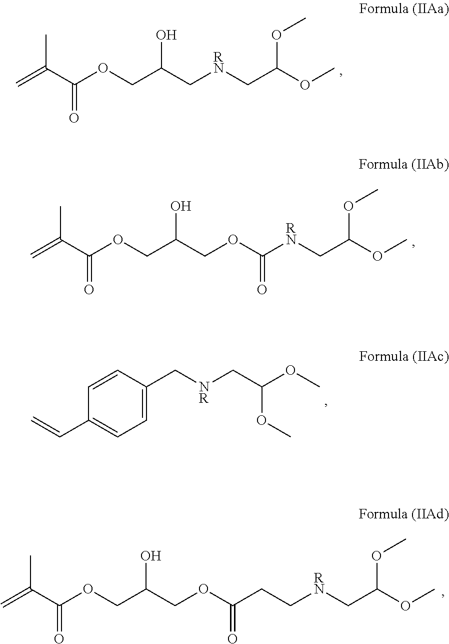

Or the reaction product of pivaldehyde with methacrylic anhydride or 4-(chloromethyl) styrene

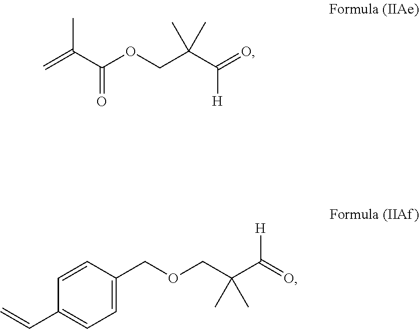 [SMILES: C=C(C)C(=O)OCC(C)(C)C=O ; C=Cc1ccc(COCC(C)(C)C=O)cc1]

In some embodiments, the aldehyde may be a polyester resin, which may be obtained by esterification or transesterification of a monomer mixture containing aldehyde-functional monomers. Such aldehyde-functional monomers may be obtained in various ways known in the arts. For example, such aldehyde-functional monomers may be based on itaconate reacted by aza-Michael addition with aminoacetaldehyde dimethyl acetal or (methylamino) acetaldehyde dimethyl acetal.

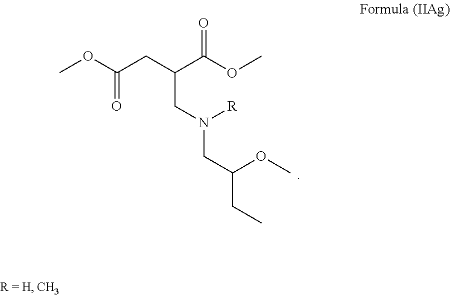

### Coating Systems

According to an embodiment, the coating system of the present disclosure includes a urea component according to Formula (I) (e.g., Formula (IA)-(IF)) as described above, and an aldehyde according to Formula (II) as described above. In some embodiments, the coating system of present disclosure may also include a solvent. In some embodiments, the urea component and aldehyde may be present at a molar ratio of 0.5 to 2.5 moles, 0.5 to 2.0 moles, 1.0 to 2.0 moles, or 1.5 to 2.5 moles of urea component for every 1 mole of the aldehyde. According to an embodiment, the coating system is crosslinkable.

According to an embodiment, the crosslinkable coating system is provided as a one-part composition or a two-part composition. The crosslinkable coating system may be a dry powder composition or a solvent-based composition. A dry powder composition is a composition where each component is in powder form. The dry powder components are blended together and may be applied in powder form. The components of a solvent-based system may be either liquid or powder, mixed into a solvent and applied in liquid form.

In embodiments where the composition is solvent-based, the coating composition includes 1 wt-% or more, 2 wt-% or more, 5 wt-% or more, 10 wt-% or more, 20 wt-% or more, 30 wt-% or more, or 40 wt-% or more of the combined urea component and aldehyde, based on total resin solids included in the coating composition. The coating composition may include 60 wt-% or less, 50 wt-% or less, 40 wt-% or less, 30 wt-% or less, 20 wt-% or less, or 10 wt-% or less of the combined urea component and aldehyde, based on total resin solids included in the coating composition.

The solvent-based composition may include water or organic solvents or a combination thereof. Exemplary solvents include ketones, acetates, aromatics, alcohols, ethers, and combinations thereof, including aqueous mixtures.

The coating composition may also optionally be rheologically modified for different coating applications. For example, the coating composition may be diluted with additional amounts of the solvent to reduce the total solids content in the coating composition. Alternatively, portions of the solvent may be removed (e.g., evaporated) to increase the total solids content in the coating composition. The final total solids content in the coating composition may vary depending on the particular coating application used, the particular coating use, the desired coating thickness, and the like.

In some embodiments, the coating composition has a total solids weight greater than about 5%, more preferably greater than about 10%, and even more preferably greater than about 15%, based on the total weight of the coating composition. In liquid embodiments, the coating composition also preferably has a total solids weight less than about 80%, more preferably less than about 60%, and even more preferably less than about 50%, based on the total weight of the coating composition. The solvent (e.g., aqueous or organic solvent) may constitute the remainder of the weight of the coating composition.

In one embodiment, the coating composition is a powder coating composition. The powder coating composition may include a base powder formed at least in part from the polymer of the present disclosure. The coating composition may include one or more optional ingredients in the particles of the base powder and/or in separate particles. Such optional ingredients may include, for example, crosslinkers, cure accelerators, colored pigments, fillers, flow additives, or the like.

The coating composition may optionally include one or more additional resins in addition to the reaction products of the urea component and aldehyde. For example, additional resins may be included to alter the properties of the resulting coating.

The coating composition may optionally include one or more additives. When used, the additives preferably enhance and preferably do not adversely affect the coating composition, or a cured coating formed from the coating composition. For example, additives may be included in the coating composition to enhance composition aesthetics, to facilitate manufacturing, processing, handling, and application of the composition, and to further improve a particular functional property of the coating composition or a cured coating resulting therefrom. Such optional additives include, for example, catalysts, dyes, pigments, toners, extenders, fillers, lubricants, anticorrosion agents, flow control agents, thixotropic agents, dispersing agents, antioxidants, adhesion promoters, light stabilizers, co-resins and mixtures thereof. Each optional additive is preferably included in a sufficient amount to serve its intended purpose, but not in such an amount to adversely affect the coating composition or a cured coating resulting therefrom.

In some embodiments, the coating composition includes one or more catalysts. In some embodiments, the coating composition includes an acid catalyst. Suitable acid catalysts are acids with a pKa of less than 7 or less than 6. An acid functionality on the polymer may also act as a catalyst.

Examples of acid catalysts include Lewis acids (e.g., boron trifluoride etherate) and protic acids (i.e., Bronsted acids). In some embodiments, the acid catalyst is an inorganic protic acid such as phosphoric acid or sulfuric acid, or an organic protic acid such as carboxylic acid, phosphonic acid, or sulfonic acid. Exemplary carboxylic acids suitable for use as acid catalysts include acetic acid, trifluoroacetic acid, and propionic acid. An exemplary phosphonic acid is methylphosphonic acid. Exemplary sulfonic acids include methanesulfonic acid, benzenesulfonic acid, camphorsulfonic acid; para-toluenesulfonic acid, and dodecylbenzenesulfonic acid (DBSA). Examples of suitable Lewis acid catalysts are aluminum trichloride (AlCl₃), benzyltriethylammonium chloride (TEBAC), Cu(O₃SCF₃)₂, (CH₃)₂BrSBr, FeCl₃ (e.g., FeCl₃·6·H₂O), HBF₄, BF₃·O(CH₂CH₃)₂, TiCl₄, SnCl₄, CrCl₂, NiCl₂, ZnBr₂, and Pd(OC(O)CH₃)₂. The acid catalyst may be unsupported (include no solid support) or supported, for example covalently bonded to a solid support.

On the other hand, amines, such as DMEA, triethylamine, other tertiary amines, and ammonia may be used to slow reactivity down.

Another useful optional additive is a lubricant (e.g., a wax), which facilitates manufacture of metal closures and other fabricated coated articles by imparting lubricity to coated metal substrates. Preferred lubricants include, for example, carnauba wax and polyethylene-type lubricants. If used, a lubricant is preferably present in the coating composition in an amount of at least about 0.1% by weight, and preferably no greater than about 2% by weight, and more preferably no greater than about 1% by weight, based on the total solids weight of the coating composition.

Another useful optional additive is an organosilicon material, such as siloxane-based or polysilicon-based materials. Representative examples of suitable such materials are disclosed in International Application Nos. WO 2014/089410 A1 and WO 2014/186285 A1.

Another useful optional ingredient is a pigment, such as titanium dioxide. If used, a pigment is present in the coating composition in an amount of no greater than about 70% by weight, more preferably no greater than about 50% by weight, and even more preferably no greater than about 40% by weight, based on the total solids weight of the coating composition.

The urea component and aldehyde may react to form a hemiaminal and may further react to form aminal (aminoacetal) and may be used to form oligomers and polymers. The reaction between a substituted urea and an aldehyde may be represented by the following two-part reaction:

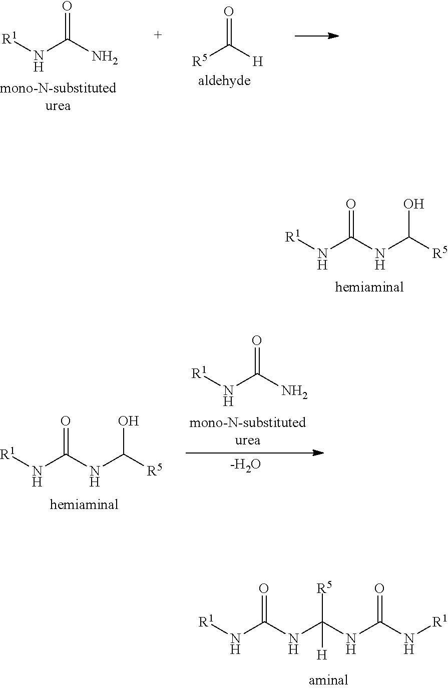

The reaction product of a mono-N-substituted urea and the aldehyde may be represented by Formula (III):

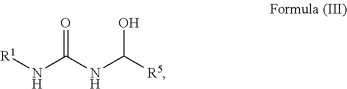

where R¹ is as in Formula (IB), and R⁵ is as in Formula (II).

A further reaction product of a mono-N-substituted urea and the aldehyde may be represented by Formula (IV):

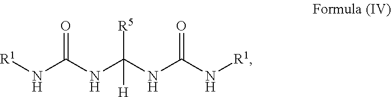

where R¹ is as in Formula (IB), and R⁵ is as in Formula (II).

Analogous reaction products may be formed between the N,N-substituted, N,N′-substituted, and N,N,N′-substituted urea and the aldehyde.

The reaction product (which forms the coating composition) may be applied onto a surface and cured to cause crosslinking. The resulting coating may be a poly(hemiaminal-urea) functionalized network (if using Formula III or an analogous reaction product) or a poly(aminal-urea) functionalized network (if using Formula IV or an analogous reaction product). According to an embodiment, the coating composition is free or substantially free of isocyanates. According to an embodiment, the coating composition is free or substantially free of formaldehyde. According to an embodiment, the coating composition is free or substantially free of both isocyanates and formaldehyde.

### Curing/Crosslinking

After having been applied onto a surface, the coating composition may be cured to cause crosslinking of the composition.

The coating composition may be cured at a temperature of 150° C. or lower, 125° C. or lower, 110° C. or lower, 100° C. or lower, 90° C. or lower, 80° C. or lower, 70° C. or lower, 60° C. or lower, 50° C. or lower, 40° C. or lower, 30° C. or lower, or 25° C. or lower. The coating composition may be cured at temperatures ranging from 0° C. to 150° C., 10° C. to 125° C., 10° C. to 90° C., 10° C. to 50° C., 10° C. to 40° C., 10° C. to 30° C., or 10° C. to 25° C. In some embodiments, the coating composition is curable at room temperature.

In some embodiments, it may be desirable for the coating composition not to react at low temperatures, such as at room temperature. The components of the coating composition may be selected to achieve desired curing and cross-linking conditions. For example, the urea component may be selected based on the following Table1 to achieve reaction conditions:

TABLE 1
Selection of Urea Component

| | Reaction | Catalyst needed |
|---|---|---|
| Urea component | temperature | for reaction |
| Mono-N-substituted urea | Room temperature | No |
| 2-Imidazolidone | Increasing reaction | Increasing need |
| N,N′-cyclic | temperature | for catalyst |
| Unsubstituted carbamate | ↓ | ↓ |
| Urea | 120° C. or greater | Yes |
| Oxyethyl urea | | |
| N,N-substituted urea | | |
| N,N′-substituted urea | | |
| N-monosubstituted carbamate | | |
| N,N,N′-substituted urea | | |

Similarly, the aldehyde may be selected to be more or less reactive based on the following Table 2:

TABLE 2
Selection of Aldehyde

| | Reaction | Catalyst needed |
|---|---|---|
| Aldehyde | temperature | for reaction |
| Cycloaliphatic aldehydes | Room temperature | No |
| Aliphatic aldehydes | Increasing reaction | Increasing need |
| Terephthalaldehyde | temperature | for catalyst |
| Glutaraldehyde (in H₂O) | ↓ | ↓ |
| Furfural | 120° C. or greater | Yes |
| Benzaldehyde | | |
| Methacrylate HMF | | |
| Dimethoxy acetaldehyde (in H₂O) | | |
| Glyoxal | | |
| Methoxyglyoxal | | |
| Vanillin salicylaldehyde | | |
| hydroxymethylfurfural | | |

The additives used in the coating composition may also be selected to achieve desired reaction conditions. For example, acid catalyst or a polymer chain bearing carboxylic acid functionalities may be used to improve reactivity of the crosslinking reaction. An amine (such as dimethylethanolamine or DMEA) may be used to slow down the reactivity.

According to embodiments, urea based crosslinking systems is at least as reactive as carbamate-based crosslinking systems.

### Methods of Coating and Coated Articles

The present disclosure provides methods of coating articles with the coating composition and articles coated with the coating composition. The coating compositions of the present disclosure may be used for many purposes and to coat various materials. The coating compositions are suitable for use as coatings for wood, wood products, metals, polymers, packaging materials, etc.

According to an embodiment, a method of coating an embodiment includes applying a coating composition to a surface of the article and curing the coating composition. The coating composition includes a urea component according to Formula (I) (e.g., Formula (IA)-(IF)) as described above, and an aldehyde according to Formula (II) as described above.

In some embodiments, a packaging article has a coating according to an embodiment of the present disclosure disposed on a surface of the packaging article. In one embodiment, the packaging article is a container such as a food or beverage container, or a portion thereof (e.g., a twist-off closure lid, beverage can end, food can end, etc.), where at least a portion of an interior surface of the container is coated with the coating composition. The coating may include a reaction product of a urea component according to Formula (I) (e.g., Formula (IA)-(IG)) as described above, and an aldehyde according to Formula (II) as described above. The coating may include a network formed from the hemiaminal of Formula (III) as described above. The coating may include a network formed from the aminal of Formula (IV) as described above. The coating may be a crosslinked coating resulting from crosslinking of the hemiaminal of Formula (III) or the aminal of Formula (IV).

### EXEMPLARY EMBODIMENTS

Embodiment 1 is a coating system comprising:
a urea component;
an aldehyde comprising two or more carbon atoms; and
a solvent.

Embodiment 2 is the coating system of embodiment 1, wherein the urea component is present at a molar ratio of 0.5 to 2.5 moles for every 1 mole of the aldebyde.

Embodiment 3 is the coating system of embodiment 1 or 2, wherein the urea component is represented by Formula (I):

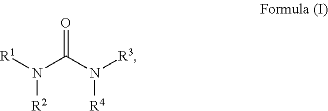

wherein R¹, R², R³, and R⁴ are independently H or a carbon-containing group, optionally further substituted with one or more oxygen, nitrogen, or sulfur atoms or a combination thereof, preferably where R¹, R², R³, and R⁴ are independently H or an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group,
wherein at least one of R¹, R², R³, and R⁴ is H, and
wherein any two of R¹, R², R³, and R⁴ may connect together to form a cyclic group.

Embodiment 4 is the coating system of any one of embodiments 1 to 3, wherein the urea component comprises urea, represented by Formula (IA):

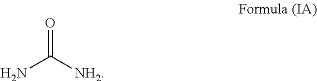

Embodiment 5 is the coating system of any one of embodiments 1 to 3, wherein the urea component comprises mono-N-substituted urea represented by Formula (IB):

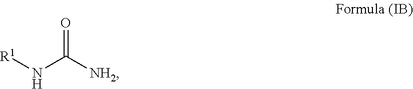

where R¹ is a carbon-containing group, optionally further substituted with one or more oxygen, nitrogen, or sulfur atoms or a combination thereof, preferably where R¹ is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group. R¹ may be straight, branched, or cyclic, and may include zero, one, or more double bonds. R¹ may include any suitable number of carbon atoms. In some embodiments, R¹ may be an oligomer or polymer.

Embodiment 6 is the coating system of any one of embodiments 1 to 3, wherein the urea component comprises N,N-substituted urea represented by Formula (IC):

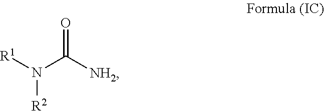

where R¹ and R² are independently carbon-containing groups, optionally further substituted with one or more oxygen, nitrogen, or sulfur atoms or a combination thereof, preferably where R¹ and R² are independently an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group. R¹ and R² may independently be straight, branched, or cyclic, and may include zero, one, or more double bonds. R¹ and R² may independently include any suitable number of carbon atoms. In some embodiments, R¹ and R² may independently be an oligomer or polymer.

Embodiment 7 is the coating system of any one of embodiments 1 to 3, wherein the urea component comprises N,N′-substituted urea represented by Formula (ID):

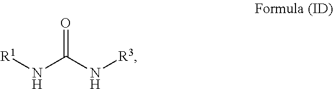

where R¹ and R³ are independently carbon-containing groups, optionally further substituted with one or more oxygen, nitrogen, or sulfur atoms or a combination thereof, preferably where R¹ and R³ are independently an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group. R¹ and R³ may independently be straight, branched, or cyclic, and may include zero, one, or more double bonds. R¹ and R³ may independently include any suitable number of carbon atoms. In some embodiments, R¹ and R³ may independently be an oligomer or polymer.

Embodiment 8 is the coating system of any one of embodiments 1 to 3, wherein the urea component comprises N,N,N′-substituted urea represented by Formula (IE):

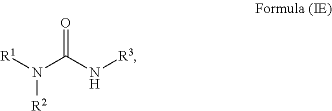

where R¹, R², and R³ are independently carbon-containing groups, optionally further substituted with one or more oxygen, nitrogen, or sulfur atoms or a combination thereof, preferably where R¹, R², and R³ are independently-an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group. R¹, R², and R³ may independently be straight, branched, or cyclic, and may include zero, one, or more double bonds. R¹, R², and R³ may independently include any suitable number of carbon atoms. In some embodiments, R¹, R², and R³ may independently be an oligomer or polymer.

Embodiment 9 is the coating system of any one of embodiments 1 to 3, wherein the urea component comprises 2-imidazolidone; glycoluril; 2-hydroxyethyl urea; methacryloxyethyl ethylene urea; biuret; methacrylamidoethyl ethylene urea, or a combination thereof.

Embodiment 10 is the coating system of any one of embodiments 1 to 3, wherein the urea component comprises di-N,N′-substituted urea represented by Formula (IF):

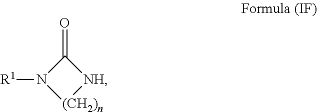

where R¹ is H or a carbon-containing group, optionally further substituted with one or more oxygen, nitrogen, or sulfur atoms or a combination thereof, preferably where R¹ is independently an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group. R¹ may be straight, branched, or cyclic, and may include zero, one, or more double bonds. R¹ may include any suitable number of carbon atoms. In some embodiments, R¹ may be an oligomer or polymer; and
where n is greater than 1, preferably where n is 2, 3, 4, 5, or 6, more preferably where n is 2 or 3.

Embodiment 11 is the coating system of any one of embodiments 1 to 3, wherein the urea component comprises di-N,N′-substituted urea represented by Formula (IG):

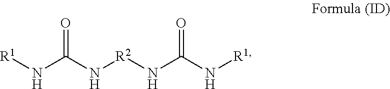

where each R¹ and R² are independently a carbon-containing group, optionally further substituted with one or more oxygen, nitrogen, or sulfur atoms or a combination thereof, preferably where each R¹ and R² are independently an alkyl, aryl, acyl, acrylate, carboxylic acid, urethane, ester, amide, carbonate, alkenyl, alkynyl, alkoxy, alcohol, amine, methacrylate, acrylamide, methacrylamide, vinyl, phenol, ketone, or alkylamine group. Each R¹ and R² may independently be straight, branched, or cyclic, and may include zero, one, or more double bonds. Each R¹ and R² may independently include any suitable number of carbon atoms. In some embodiments, each R¹ and R² may independently be an oligomer or polymer.

Embodiment 12 is the coating system of any one of embodiments 1 to 3 or 11, wherein the urea component is part of an oligomer comprising a plurality of unsubstituted or substituted urea functional groups.

Embodiment 13 is the coating system of any one of embodiments 1 to 12, wherein the aldehyde may be represented by Formula (II) or (IIA):

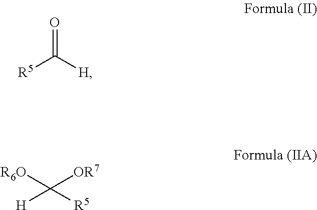

where R⁵ is a carbon-containing group, optionally further substituted with one or more oxygen, nitrogen, or sulfur atoms or a combination thereof, preferably where R⁵ is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, optionally wherein the aldehyde is in a protected form comprising an acetal or a hydrate. The aldehyde may be a monoaldehyde. The aldehyde may be a polyaldehyde. The aldehyde may be an oligomer. And where each R⁶ and R⁷ are independently carbon-containing groups, optionally further substituted with one or more oxygen, nitrogen, or sulfur atoms or a combination thereof, preferably where each R⁶ and R⁷ are independently an alkyl, aryl, acyl, acrylate, carboxylic acid, urethane, ester, amide, carbonate, alkenyl, alkynyl, alkoxy, alcohol, amine, methacrylate, acrylamide, methacrylamide, vinyl, phenol, ketone, alkylamine or urea group. Each R⁶ and R⁷ may independently be straight, branched, or cyclic, and may include zero, one, or more double bonds. Each R⁶ and R⁷ may independently include any suitable number of carbon atoms. In some embodiments, each R⁶ and R⁷ may independently be an oligomer or polymer. In preferred embodiments, R⁶ and R⁷ are independently a carbon-containing group with one to four carbon atoms. In some preferred embodiments, the R⁶ and R⁷ groups on the acetal of Formula (IIA) are such that R⁶═R⁷. In some embodiments, R⁶ and R⁷ may be bonded to form a cyclic acetal. In some embodiments, the aldehyde in the crosslinkable coating systems of the present disclosure is a polyaldehyde. In some embodiments, the polyaldehyde in the crosslinkable coating systems of the present disclosure is chosen from a group consisting of terephthaldehyde, glutaraldehyde, glyoxal, dimethoxy acetaldehyde, methylglyoxal, cyclohexanedicarbaldehyde, malondialdehyde bis(dimethyl acetal), 5,5′-(oxy-bis(methylene))bis-2-furfural, bis(dimethyl acetal) of imidazolidone, tetra-dimethyl acetal of glycoluryl, bis(dimethyl acetal) of polyglycidyl ether, tri (aminoethyl dimethyl acetal) of itaconic, tri (aminoethyl dimethyl acetal) of TMPEOTA, poly(dimethyl acetal) of polycyclocarbonate.

Embodiment 14 is the coating system of any one of embodiments 1 to 13, wherein the aldehyde comprises a monoaldehyde.

Embodiment 15 is the coating system of any one of embodiments 1 to 13, wherein the aldehyde comprises a polyaldehyde.

Embodiment 16 is the coating system of any one of embodiments 1 to 15, wherein the aldehyde is an oligomer.

Embodiment 17 is the coating system of any one of embodiments 1 to 16, wherein the urea component and the aldehyde form a reaction product represented by Formula (III):

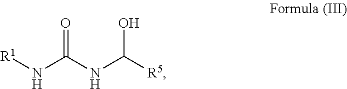

wherein R¹ is a carbon-containing group, optionally further substituted with one or more oxygen, nitrogen, or sulfur atoms or a combination thereof, preferably where R¹ is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, and R⁵ is as in Formula (II).

Embodiment 18 is the coating system of any one of embodiments 1 to 16, wherein the urea component and the aldehyde form a further reaction product represented by Formula (IV):

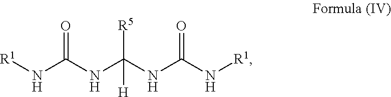

wherein R¹ is a carbon-containing group, optionally further substituted with one or more oxygen, nitrogen, or sulfur atoms or a combination thereof, preferably where R¹ is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, and R⁵ is as in Formula (II).

Embodiment 19 is the coating system of any one of embodiments 1 to 18, wherein the coating system is free or substantially free of formaldehyde.

Embodiment 20 is the coating system of any one of embodiments 1 to 19, wherein the coating system is free or substantially free of isocyanate.

Embodiment 21 is the coating system of any one of embodiments 1 to 20, wherein the coating system is curable at a temperature of 150° C. or lower, 125° C. or lower, 110° C. or lower, 100° C. or lower, 90° C. or lower, 80° C. or lower, 70° C. or lower, 60° C. or lower, 50° C. or lower, 40° C. or lower, 30° C. or lower, or 25° C. or lower. The coating composition may be cured at temperatures ranging from 0° C. to 150° C., 10° C. to 125° C., 10° C. to 90° C., 10° C. to 50° C., 10° C. to 40° C., 10° C. to 30° C., or 10° C. to 25° C. In some embodiments, the coating composition is curable at room temperature.

Embodiment 22 is the coating system of any one of embodiments 1 to 21, wherein the coating system comprises 1 wt-% or more, 2 wt-% or more, 5 wt-% or more, 10 wt-% or more, 20 wt-% or more, 30 wt-% or more, or 40 wt-% or more of the combined urea component and aldehyde, based on total resin solids included in the coating composition. The coating system may include 60 wt-% or less, 50 wt-% or less, 40 wt-% or less, 30 wt-% or less, 20 wt-% or less, or 10 wt-% or less of the combined urea component and aldehyde, based on total resin solids included in the coating system.

Embodiment 23 is the coating system of any one of embodiments 1 to 22, wherein the coating system comprises an acid catalyst, optionally wherein the acid catalyst has a pKa of less than 7 or less than 6.

Embodiment 24 is the coating system of embodiment 23, wherein the acid catalyst comprises phosphoric acid, sulfuric acid, acetic acid, trifluoroacetic acid, propionic acid, methylphosphonic acid, methanesulfonic acid, benzenesulfonic acid, camphorsulfonic acid, para-toluenesulfonic acid (PTSA), dodecylbenzenesulfonic acid (DBSA), aluminum trichloride (AlCl₃), benzyltriethylammonium chloride (TEBAC), Cu(O₃SCF₃)₂, (CH₃)₂BrSBr, FeCl₃, HBF₄, BF₃·((CH₂CH₃)₂, TiCl₄, SnCl₄, CrCl₂, NiCl₂, ZnBr₂, Pd(OC(O)CH₃)₂, or a combination thereof.

Embodiment 25 is a coating system comprising a reaction product of: a urea component; and an aldehyde comprising two or more carbon atoms.

Embodiment 26 is the coating system of embodiment 25, wherein the reaction product is a crosslinked product of Formula (III):

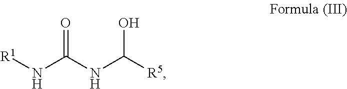

wherein R¹ is a carbon-containing group, optionally further substituted with one or more oxygen, nitrogen, or sulfur atoms or a combination thereof, preferably where R¹ is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, and R⁵ is as in Formula (II).

Embodiment 27 is the coating system of embodiment 25, wherein the reaction product is a crosslinked product of Formula (IV):

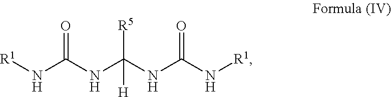

wherein R¹ is a carbon-containing group, optionally further substituted with one or more oxygen, nitrogen, or sulfur atoms or a combination thereof, preferably where R¹ is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, and R⁵ is as in Formula (II).

Embodiment 28 is the coating system of any one of embodiments 25 to 27, wherein the coating system is in powder form.

Embodiment 29 is the coating system of any one of embodiments 1 to 27, wherein the coating system comprises an organic solvent, water, or both.

Embodiment 30 is the coating system of any one of embodiments 25 to 29, wherein the coating system is free or substantially free of formaldehyde and structural units derived from formaldehyde.

Embodiment 31 is the coating system of any one of embodiments 25 to 31, wherein the coating system is free or substantially free of isocyanate and structural units derived from isocyanate. Embodiment 32 is an article coated with the coating system of any one of the preceding embodiments.

### EXAMPLES

### Example 1

### Synthesis of bis-urea From diamine and methyl carbamate

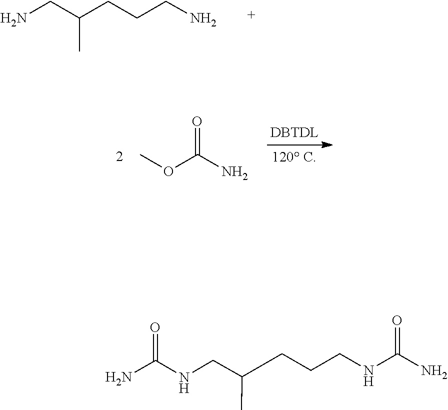

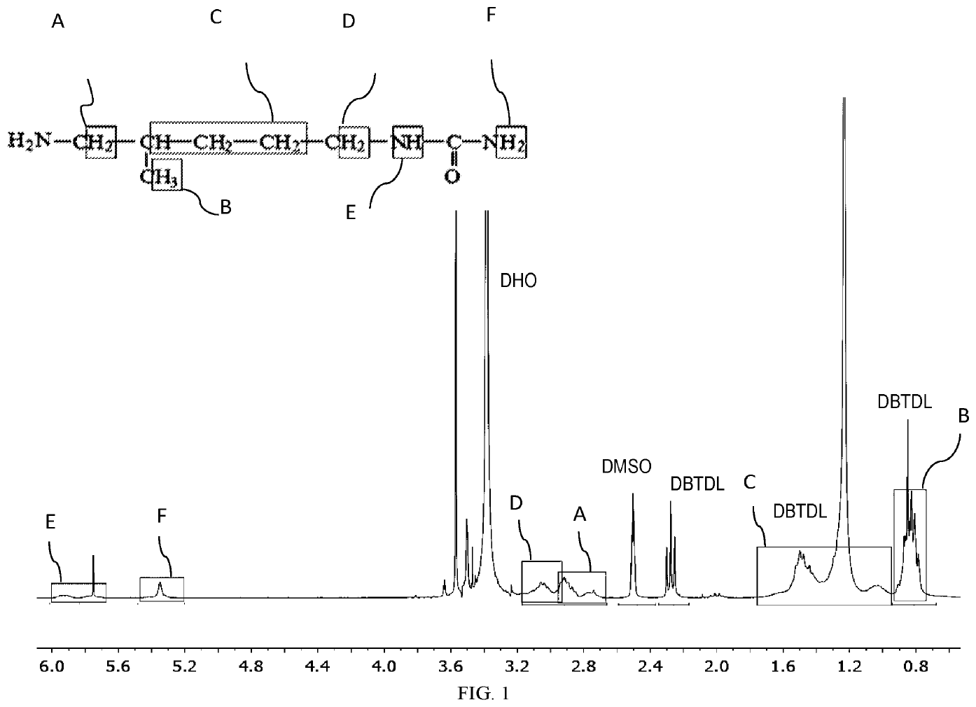

5 g of 2-methylpentane-1,5-diamine and 32.3 g of methyl carbamate were loaded into a reaction vessel equipped with a Dean-Stark distillation column. Dibutyl tin dilaurate (“DBTDL”) was added to the reaction vessel and the reaction mixture heated to 120° C. for 6 to 10 hours. The resultant methanol formed during the reaction was distilled off. The reaction procedure furnished the product in 42% yield. The product was analyzed by ¹H-NMR. The resulting spectrum is shown in FIG. 1.

### Example 2

### Synthesis of bis-urea from dodecane diamine and urea

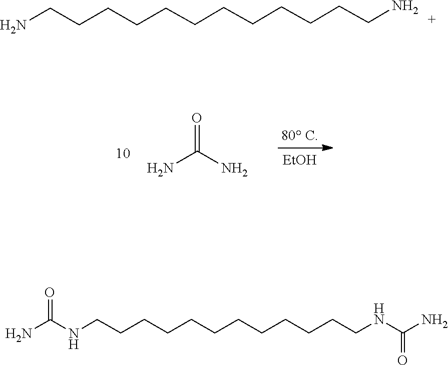

30 g (0.5 moles) of urea was added to 100 g of ethanol. The reaction mixture was stirred at 80° C. until complete dissolution of the urea. Next, 10 g (0.05 moles) of dodecane diamine was added to the reaction vessel and the reaction mixture continued to be stirred at 80° C. for 10 hours. Next, the reaction mixture was allowed to cool leading to the bis-urea product to precipitate out into ethanol. The precipitates were strained and rinsed with cold ethanol. The product was then dried at room temperature. The reaction and purification furnished the product in 12 g (84%) yield.

### Example 3

### Synthesis of bis-urea from Diethylenetriamine (DETA) and urea

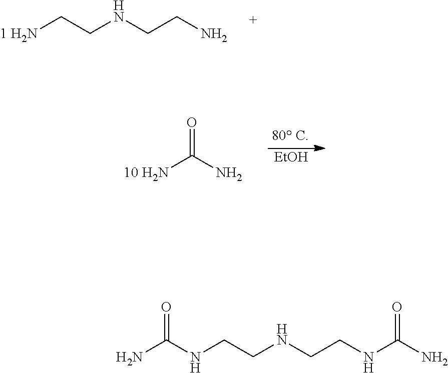

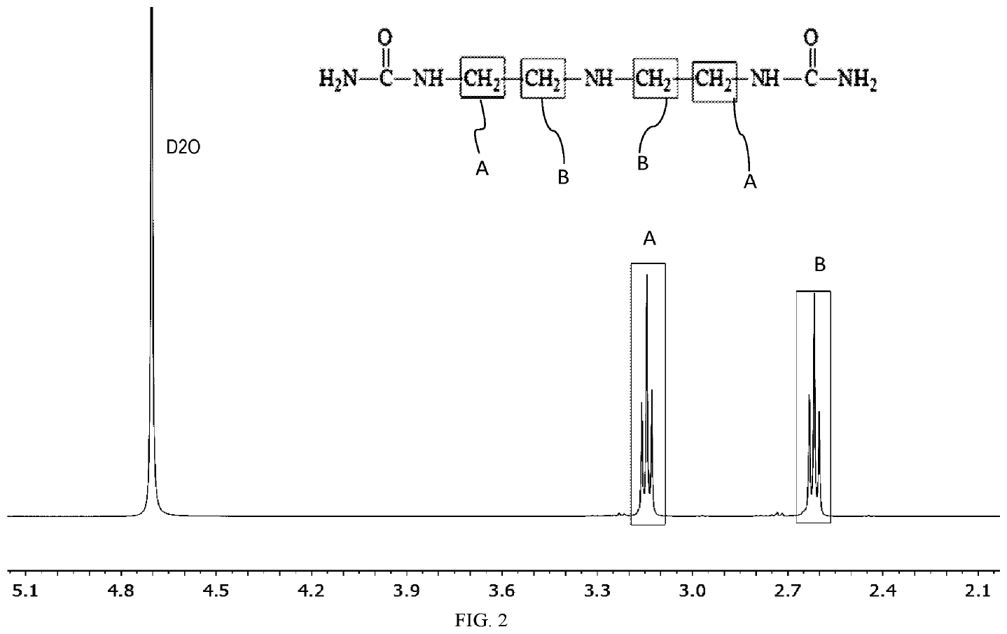

30 g (0.5 moles) of urea was added to 100 g of ethanol. The reaction mixture was stirred at 80° C. until complete dissolution of the urea. Next, 5.15 g (0.05 moles) of diethylenetriamine was added to the reaction vessel and the reaction mixture continued to be stirred at 80° C. for 10 hours. Next, the reaction mixture was allowed to cool leading to the diurea product to precipitate out into ethanol. The precipitates were strained and rinsed with cold ethanol. The product was then dried at room temperature. The reaction and purification furnished the product in 6 g (63%) yield. The product was analyzed by ¹H-NMR. The resulting ¹H-NMR spectrum of the product is shown in FIG. 2.

### Example 4

### Synthesis of hydroxyethyl urea methacrylate (HEUMA) from MAAH and 2-hydroxyethyl urea

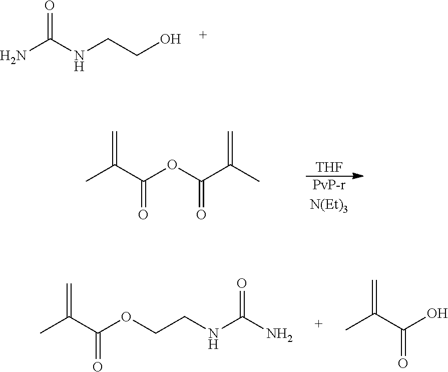

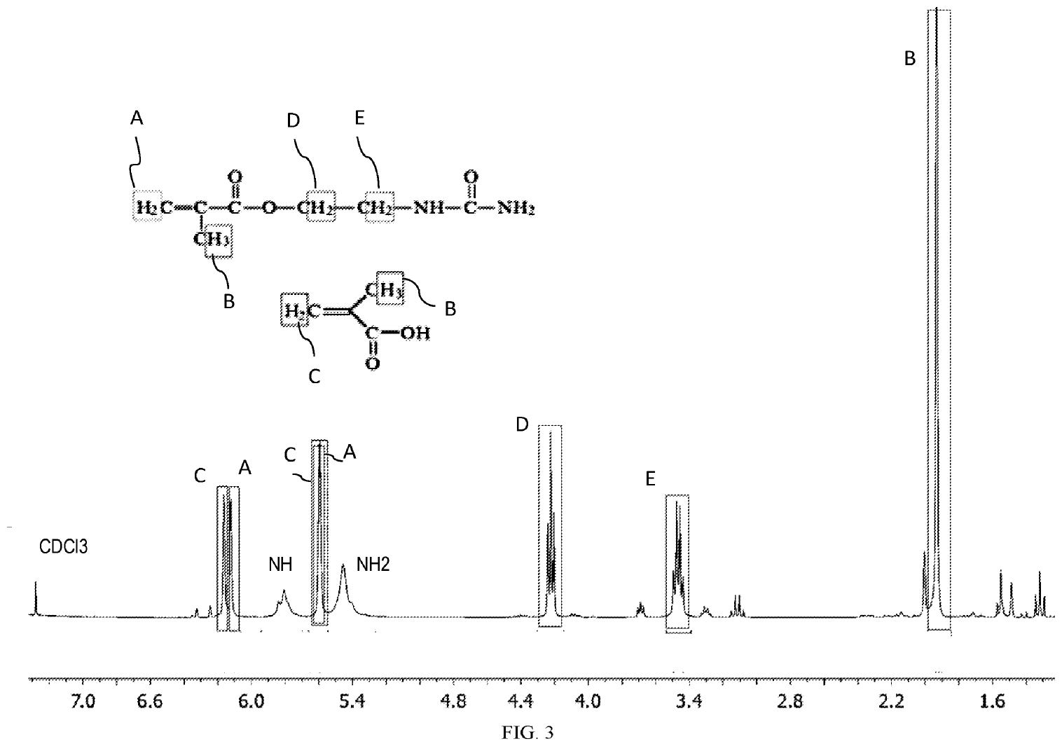

30 g (0.5 moles) of 2-hydroxyethyl urea was added to 120 g of THF, 0.67 g (0.005 moles) of triethylamine and 0.58 g (0.005 moles) of cross-linked polyvinyl pyridine (2%) were placed in a reaction vessel. The reaction mixture was stirred at 60° C. until complete dissolution of the urea. Next, 42.2 g (0.274 moles) of methacrylic anhydride (MAAH) was added to the reaction vessel and the reaction mixture stirred at 50° C. for 10 hours. After allowing the reaction mixture to cool, the THF was filtered and evaporated and 72 g of DOWANOL™ PM (available from Dow Chemical in Midland, MI) was added to it. The product was used as is with a dry content of 50%. The product was analyzed by ¹H-NMR. The resulting ¹H-NMR spectrum of the product is shown in FIG. 3.

### Example 5

### Synthesis of bis-urea methacrylamide from MAAH and Example 3 (bis-urea DETA)

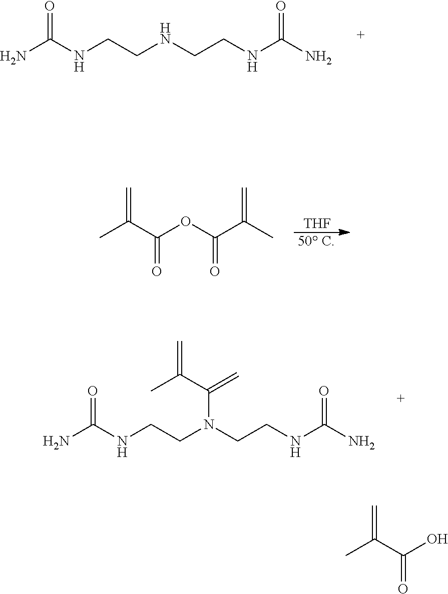

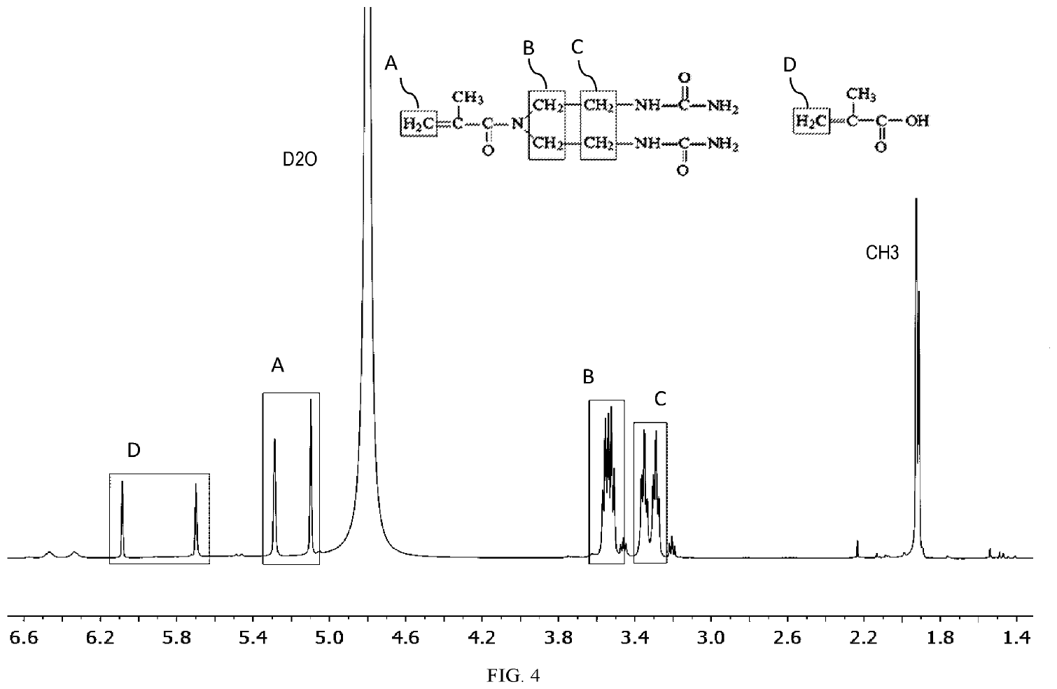

10 g (0.053 moles) of bis-urea DETA (from Example 3) was added to 40 g of THF. The reaction mixture was stirred at 50° C. until complete dissolution of the bis-urea. Next. 8.15 g (0.053 moles) of methacrylic anhydride (MAAH) was added to the reaction vessel and the reaction mixture continued to be stirred at 50° C. for 10 hours. After allowing the reaction mixture to cool, the THF was filtered and evaporated and 18.2 g of DOWANOL™ PM was added to it. The product was used as is with a dry content of 50%. The product was analyzed by ¹H-NMR. The resulting ¹H-NMR spectrum of the product is presented herein (FIG. 4):

### Example 6

### Synthesis of N,N′-disubstituted urea diol from monoethanolamine and urea

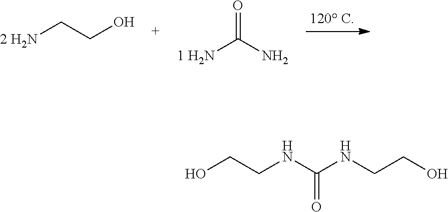

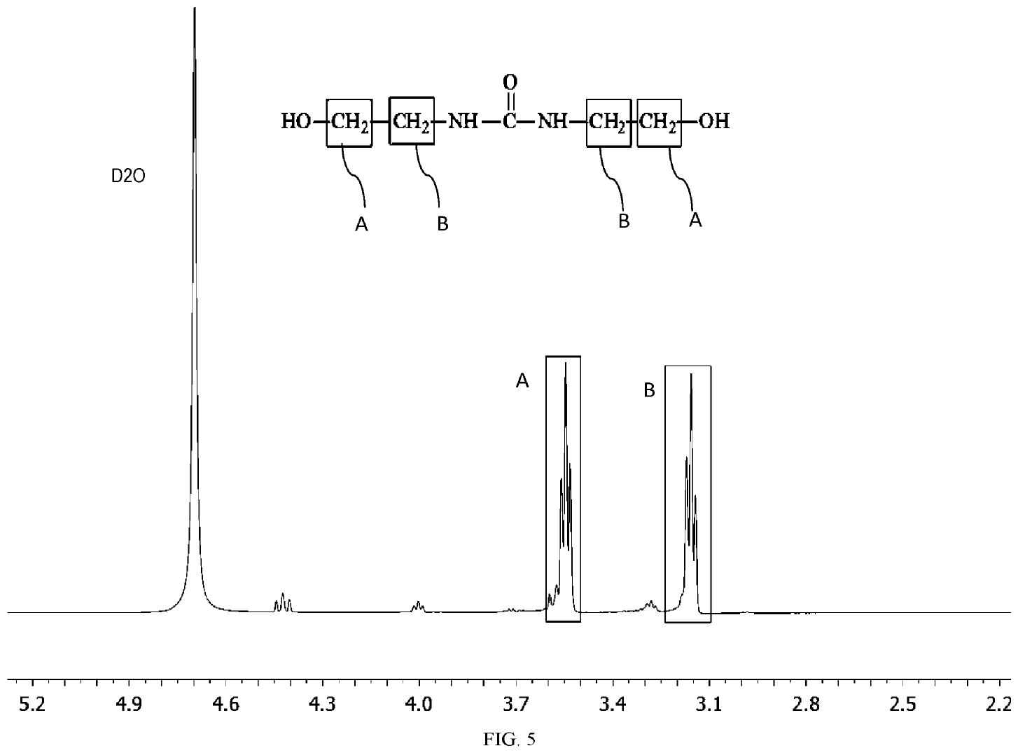

30 g (0.5 moles) of urea was added to 61 g (0.05 moles) of monoethanolamine in a reaction vessel and the reaction mixture heated at 100° C. for 3 hours, followed by 120° C. for another 3 hours. Next, the reaction mixture was allowed to cool leading to the crystallization of the product. The product was analyzed by ¹H-NMR and used as is without further purification. The ¹H-NMR spectrum of the product is shown in FIG. 5.

### Example 7

### Synthesis of N,N-disubstituted urea diol from diethanolamine and urea

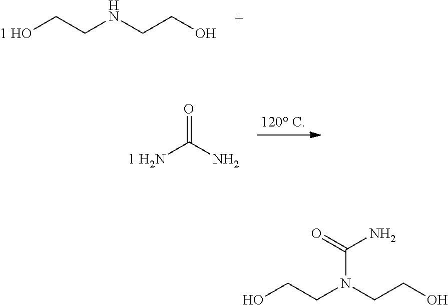

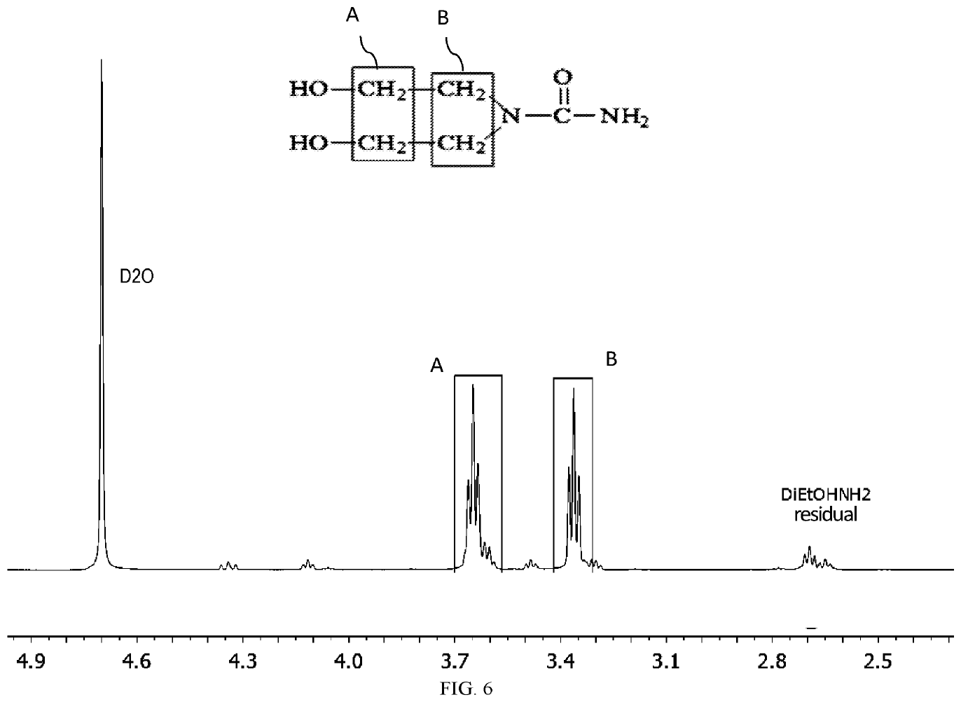

30 g (0.5 moles) of urea was added to 52.5 g (0.5 moles) of diethanolamine in a reaction vessel and the reaction mixture heated at 100° C. for 3 hours, followed by 120° C. for another 3 hours. Next, the reaction mixture was allowed to cool leading to crystallization of the product, which was analyzed by ¹H-NMR and used as is without further purification. The ¹H-NMR spectrum of the product is shown in FIG. 6.

### Example 8

### Synthesis of monosubstituted urea diacid from hydroxyethyl urea and trimellitic anhydride (TMA)

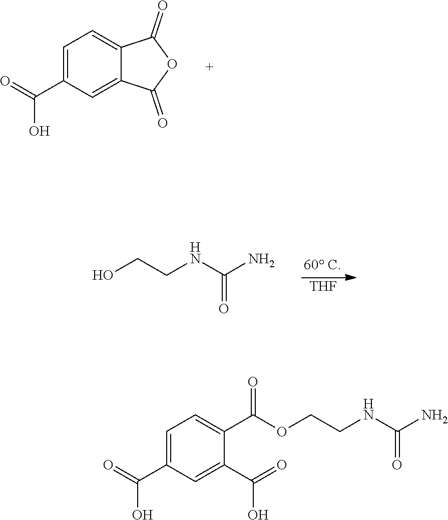 [SMILES: O=C(O)c1ccc2c(c1)C(=O)OC2=O ; NC(=O)NCCO ; NC(=O)NCCOC(=O)c1ccc(C(=O)O)cc1C(=O)O ; "THF"]

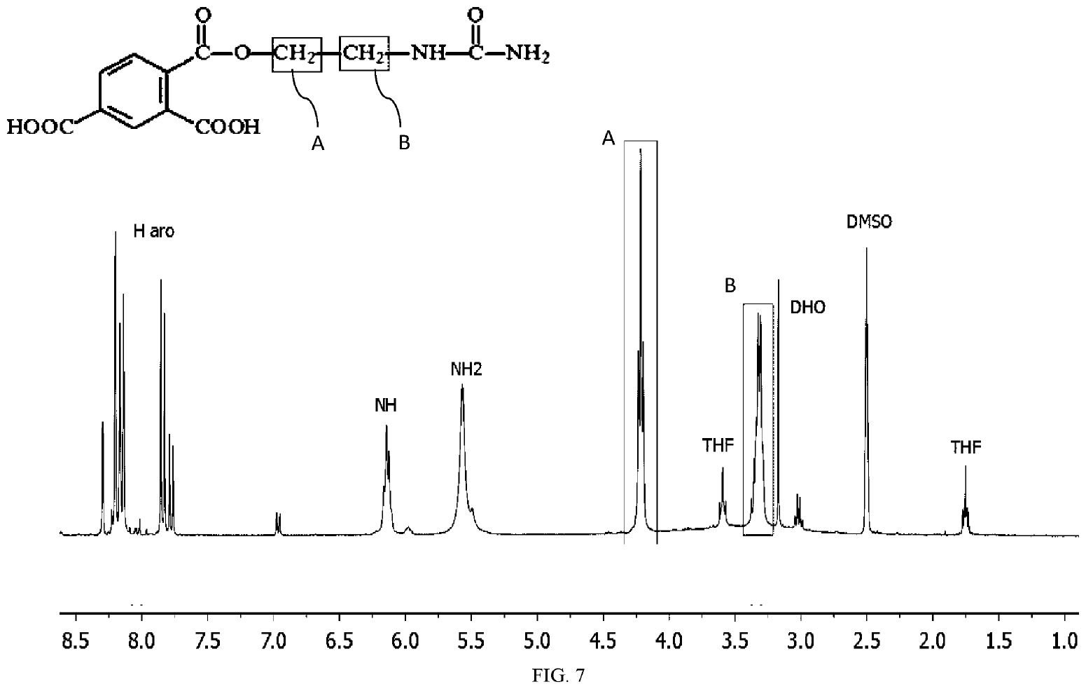

27.1 g (0.2602 moles) of 2-hydroxyethyl urea. 50 g (0.2602 moles) of trimellitic anhydride and 231 g of THF were loaded into a 500 ml reaction vessel, and the reaction mixture stirred at 60° C. Next, 0.77 g of DMAP was added to the reaction vessel and the reaction mixture was continued to be stirred at 60° C. for 10 hours. Next, the reaction mixture was allowed to cool. Addition of 300 g of dichloromethane to it led to the product precipitating out of the reaction mixture. The product was recovered by filtration and drying. The reaction procedure as described furnished the product as a white powder in 69 g (90%) yield. The product was analyzed by ¹H-NMR. The ¹H-NMR spectrum of the product is shown in FIG. 7.

### Example 9

### Synthesis of dimethyl acetal methacrylamide from MAAH and aminoacetaldehyde dimethyl acetal

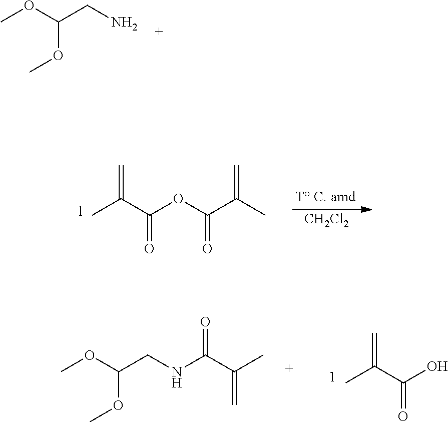

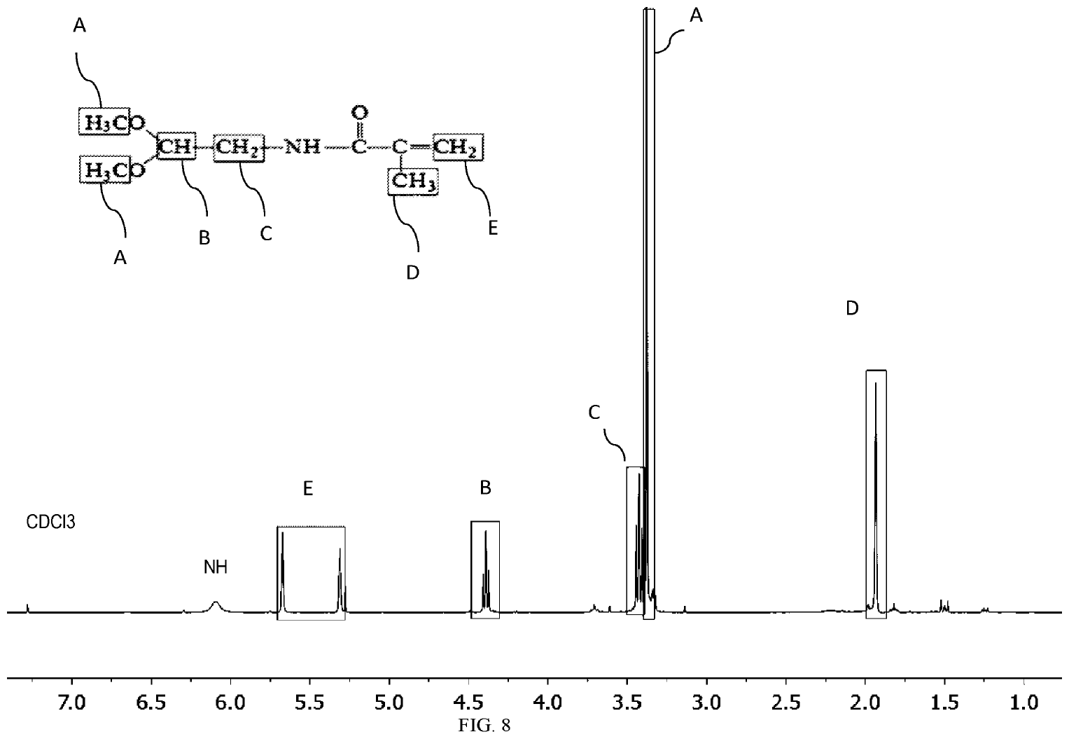

70 g (0.67 moles) of aminoacetaldehyde dimethyl acetal and 300 g of dichloromethane were loaded into a 500 ml reaction vessel under constant stirring. 102.64 g (0.67 moles) of methacrylic anhydride (MAAH) was added to the reaction vessel and the reaction mixture stirred at 50° C. for 10 hours. Next, the reaction mixture was allowed to cool and placed in a settling ampoule. 100 ml of a basic aqueous solution was added to it for the removal of acrylic acid, followed by rinsing with a neutral aqueous solution. Removal of solvent furnished the product as a pure viscous liquid in 95% yield. The product was analyzed by ¹H-NMR. The ¹H-NMR spectrum of the product is shown in FIG. 8.

### Example 10

### Synthesis of polyacetal from polyacrylate and aminoacetaldehyde dimethyl acetal

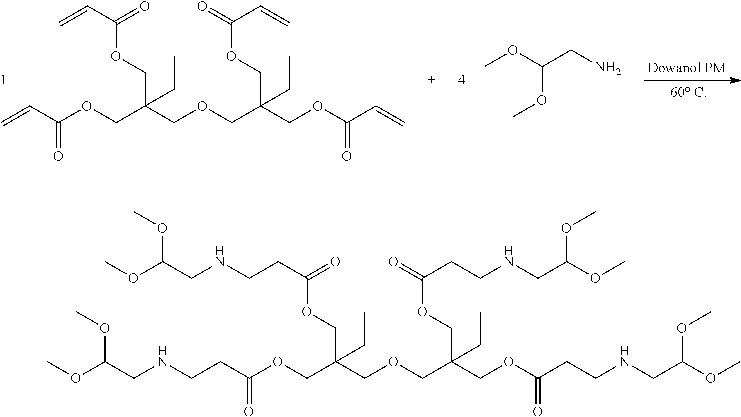

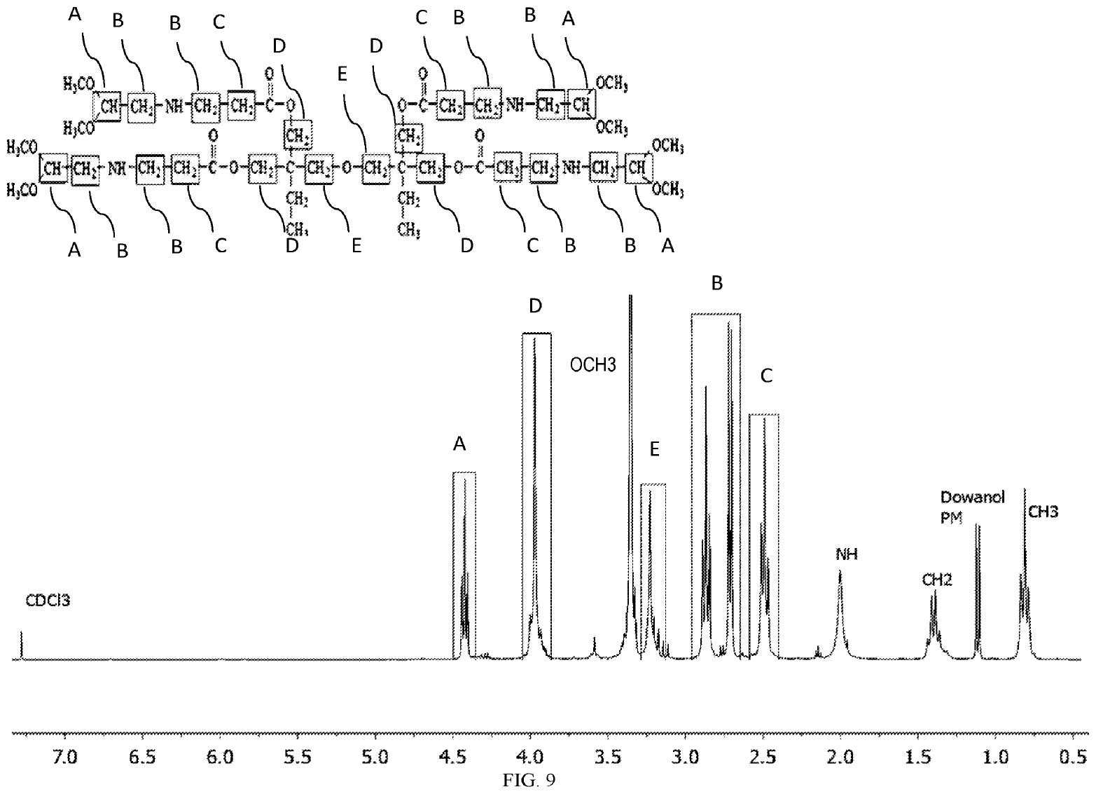

10 g (0.021 moles) of di(trimethylolpropane) tetraacrylate, 9 g (0.086 moles) of aminoacetaldehyde dimethyl acetal, and 19 g of DOWANOL™ PM were loaded into a 100 ml reaction vessel and the reaction mixture stirred at 50° C. for 10 hours. The resulting product was used as is without any further purification. The reaction product was obtained with a dry content of 50% yield. The product was analyzed by ¹H-NMR. The ¹H-NMR spectrum of the product is shown in FIG. 9.

### Example 11

### Synthesis of polyacetal from trimethylolpropane ethoxylate triacrylate and aminoacetaldehyde dimethyl acetal

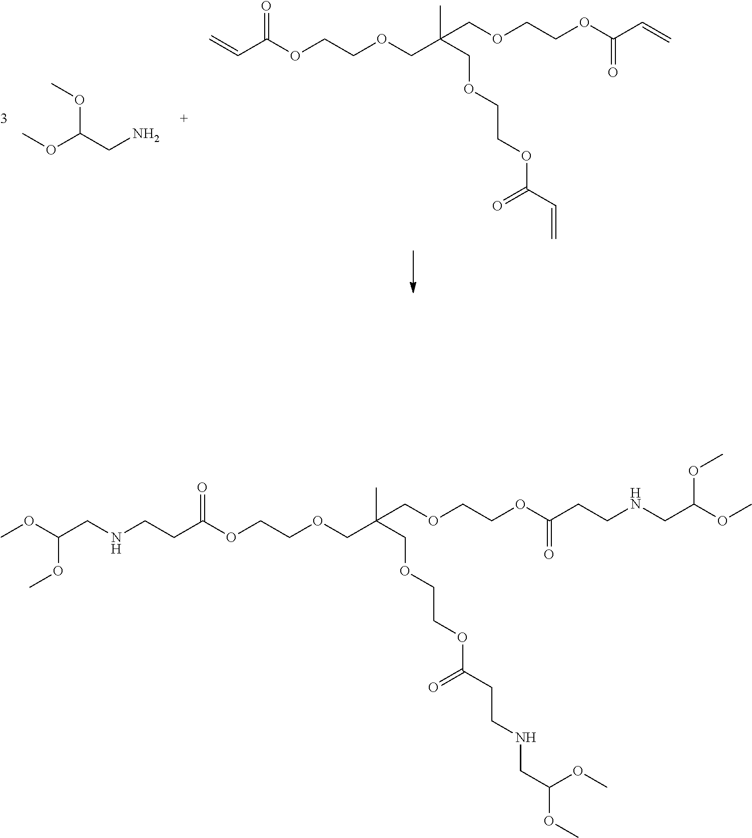

45.06 g of aminoacetaldehyde dimethyl acetal was loaded in a reaction vessel equipped with a condenser, a stirrer, and a temperature probe. 42.33 g of trimethylolpropane ethoxylate triacrylate was slowly added to the reaction vessel over ten minutes at room temperature to control the exotherm. The reaction mixture was then stirred at 60° C. for 6 hours.

### Example 12

### Synthesis of polyacetal from bisphenol A diglycidyl ether (BADGE) and aminoacetaldehyde dimethyl acetal

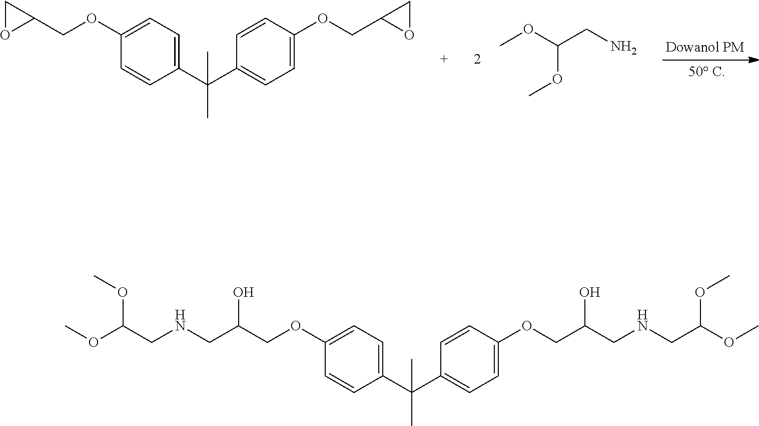

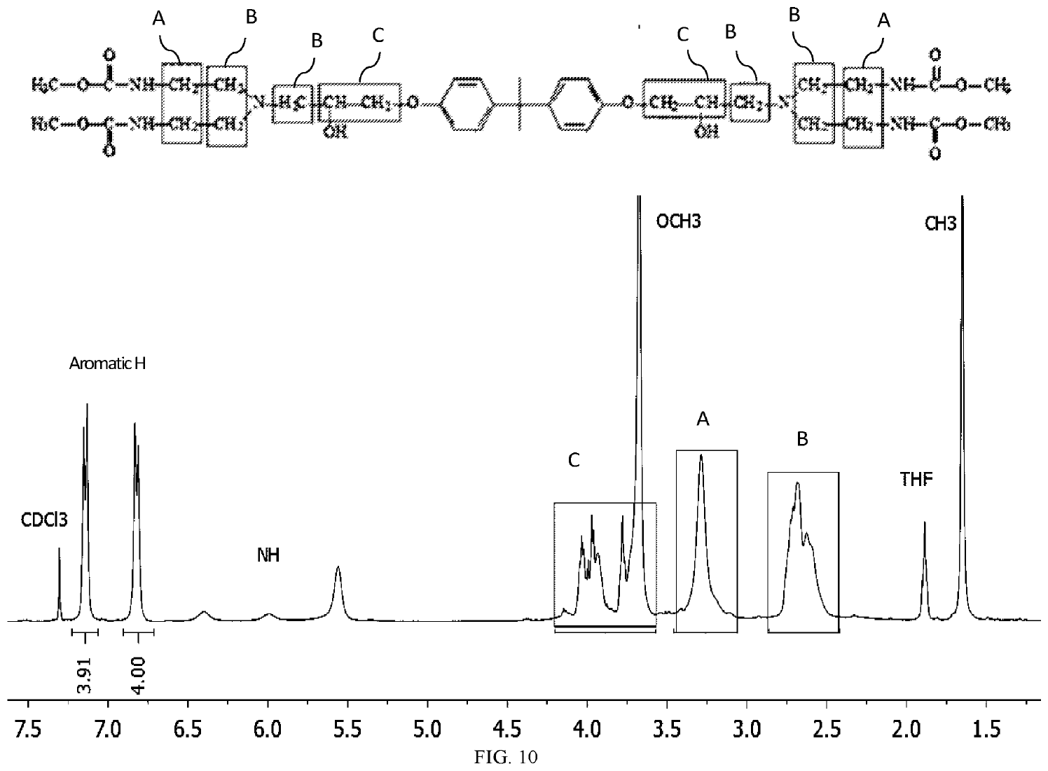

20 g (0.107 moles epoxy) of bisphenol A diglycidyl ether (BADGE), 11.44 g (0.109 moles) of aminoacetaldehyde dimethyl acetal and 31.4 g of DOWANOL™ PM were loaded into a 250 ml reaction vessel and the reaction mixture stirred at 50° C. for 10 hours. The resulting reaction mixture was used as is with a dry content of 50%. The crude reaction product was analyzed by ¹H-NMR. The ¹H-NMR spectrum of the crude reaction product is shown in FIG. 10.

### Example 13

### Synthesis of polyacetal from itaconate and aminoacetaldehyde dimethyl acetal

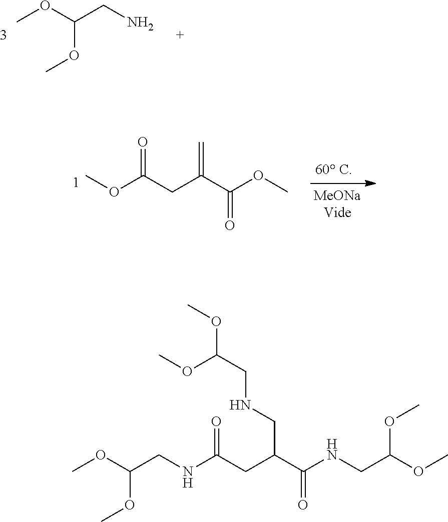

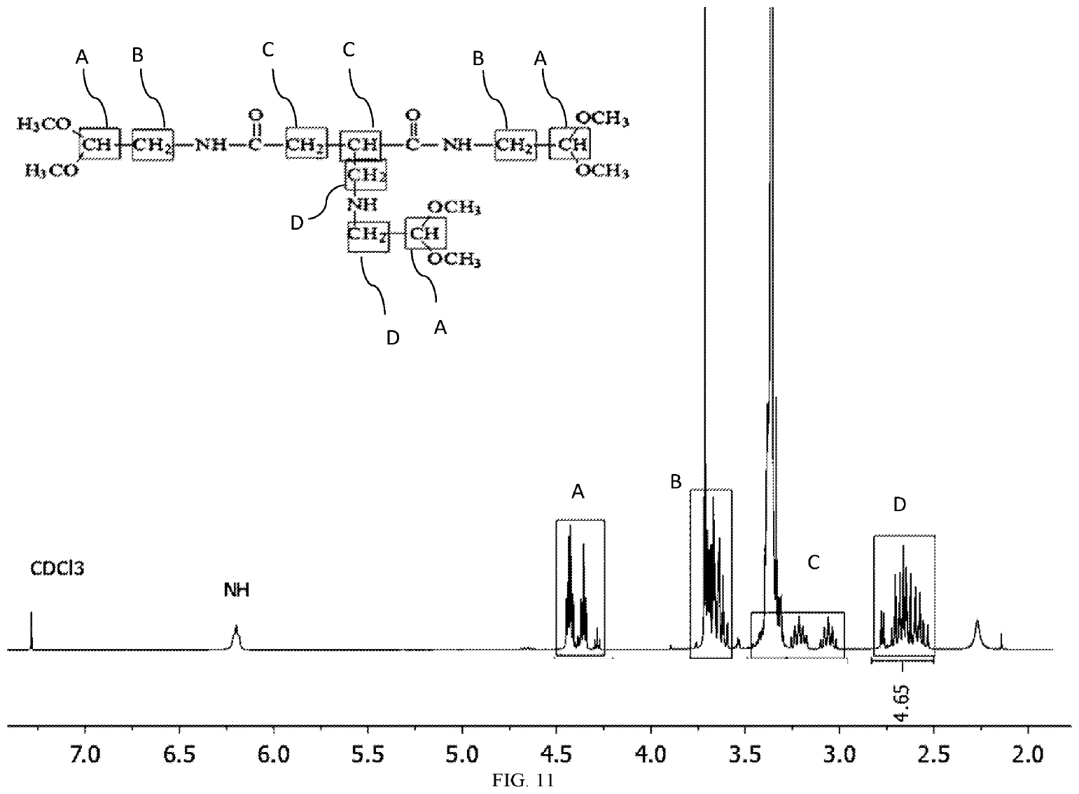

40 g (0.253 moles) of dimethyl itaconate and 79.8 g (0.253 moles) of aminoacetaldehyde dimethyl acetal were loaded into a reaction vessel and the reaction mixture heated to 60° C. while being stirred Once the temperature reached 60° C., 0.125 g (0.3 wt-%) sodium methoxide was added to the reaction vessel. The reaction vessel was then placed under vacuum of 120 mm Hg for 10 hours. The product is obtained as a pure viscous liquid and used as is, without any further purification. The crude reaction product was analyzed by ¹H-NMR and the spectrum is shown in FIG. 11.

### Example 14

### Synthesis of polyacetal from imidazolidone and glyoxal dimethyl acetal

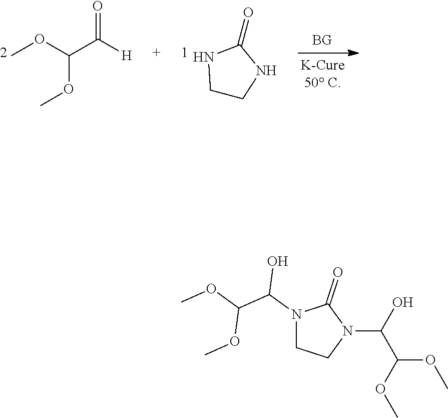

5 g (0.058 moles) of 2-imidazolidone and 9 g of DOWANOL™ PM were loaded into a 100 ml reaction vessel and the reaction mixture stirred at 50° C. until complete dissolution of 2-imidazolidone. Next, 20 g (0.115 moles) of glyoxal dimethyl acetal and 0.25 g of K-cure (1 wt-%) were added to the reaction vessel and the reaction mixture continued to be stirred at 50° C. for 10 hours. The product, with a dry content of 50%, is used as is, without any further purification.

### Example 15

### Synthesis of polyacetal from polycyclocarbonate and aminoacetaldehyde dimethyl acetal

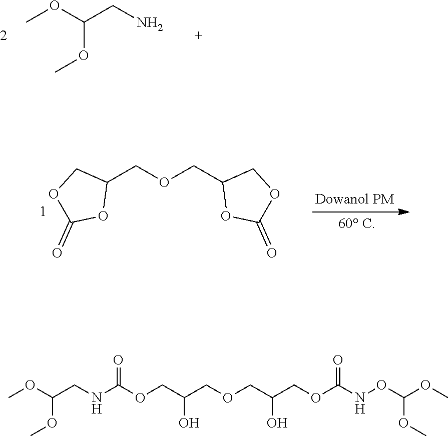

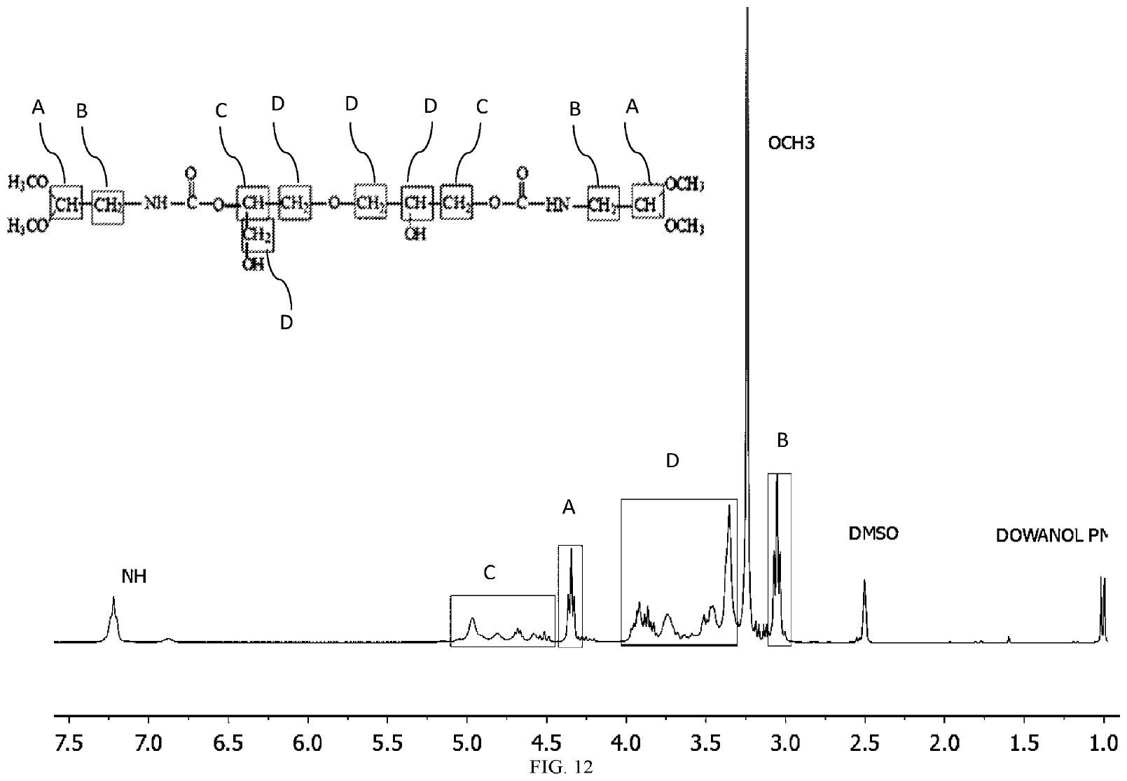

10 g (0.095 moles) of aminoacetaldehyde dimethyl acetal, 10.4 g (0.0478 moles) of diglycerol dicyclocarbonate, and 20.4 g of DOWANOL™ PM were loaded into a 100 ml reaction vessel and the reaction mixture stirred at 50° C. for 10 hours. The product, with a dry content of 50%, is used as is, without any further purification. The crude reaction product was analyzed by ¹H-NMR and the spectrum is shown in FIG. 12.

### Example 16

### Radical copolymerization of UMA 25% in solvent based acrylic resin

210 g of butyl glycol was loaded into a reaction vessel equipped with a condenser, a stirrer, and a temperature probe, and stirred at 115° C. under an inert nitrogen atmosphere. A mixture of 277.2 g of UMA 25%, 37.8 g of methacrylic acid and 9.45 g of TRIGONOX® 21S (available from Nouryon Functional Chemicals B. V. in Radnor, PA) was slowly added to the reaction vessel over two hours at a constant rate. The reaction mixture was continued to be stirred at 115° C. for 3 hours, followed by the addition of 105 g of distilled water to reach a non-volatile component value of 50%. As a result, an acrylic resin with a urea equivalent weight of 900.9 on solid and an acid value of 78.2 was obtained.

### Example 17

Radical copolymerization of hydroxypropylcarbamate acrylate in solvent based acrylic resin 210 g of butyl glycol was loaded into a reaction vessel equipped with a condenser, a stirrer, and a temperature probe, and stirred at 115° C. under an inert nitrogen atmosphere. A mixture of 60.6 g of hydroxypropyl carbamate acrylate, 216.6 g of methyl methacrylate, 37.8 g of methacrylic acid and 9.45 g of TRIGONOX® 21S was slowly added to the reaction vessel over two hours at a constant rate. The reaction mixture was continued to be stirred at 115° C. for 2 hours, followed by the addition of 105 g of butyl glycol to reach a non-volatile component value of 50%. As a result, an acrylic resin with a carbamate equivalent weight of 900.0 on solid and an acid value of 78.2 was obtained.

### Example 18

### Radical Copolymerization of Hydroxyethyl Urea Methacrylate HEUMA (Example 4) in Solvent Based Acrylic Resin

210 g of butyl glycol was loaded into a reaction vessel equipped with a condenser, a stirrer, and a temperature probe, and stirred at 115° C. under an inert nitrogen atmosphere. A mixture of 60.2 g of hydroxyethyl urea methacrylate HEUMA (from Example 4), 217 g of methyl methacrylate, 37.8 g of methacrylic acid and 9.45 g of TRIGONOX® 21S was slowly added to the reaction vessel over two hours at a constant rate. The reaction mixture was continued to be stirred at 115° C. for 2 hours, followed by the addition of 105 g of distilled water to reach a non-volatile component value of 50%. As a result, an acrylic resin with a urea equivalent weight of 900.5 on solid and an acid value of 78.2 was obtained.

### Example 19

### Radical Copolymerization of Dimethyl Acetal Methacrylamide (Example 9) in Solvent Based Acrylic Resin

168 g of butyl glycol was loaded into a reaction vessel equipped with a condenser, a stirrer, and a temperature probe, and stirred at 115° C. under an inert nitrogen atmosphere. A mixture of 48.4 g of dimethyl acetal methacrylamide (from Example 9), 188.1 g of methyl methacrylate, 15.5 g of methacrylic acid and 7.56 g of TRIGONOX® 21S was slowly added to the reaction vessel over two hours at a constant rate. The reaction mixture was continued to be stirred at 115° C. for 4 hours, followed by the addition of 84 g of butyl glycol to reach a non-volatile component value of 50%. As a result, an acrylic resin with an aldehyde equivalent weight of 901.5 on solid and an acid value of 40.1 was obtained.

### Example 20

Comparative coating evaluation of Examples 16, 17, and 18

### Example 20.a

24 g (0.013 eq. urea) of acrylic resin of Example 16, 15 g of butyl glycol and 1.01 g (0.013 eq aldehyde) of a mixture of 1,3-cyclohexanedicarboxaldehyde and 1,4-cyclohexanedicarboxaldehyde (PARALOID™ EDGE XL-195 available from Parmer Holland in Westlake, OH)) were mixed together. The acid functional groups were neutralized with 1.41 g of dimethylethanolamine (DMEA). The resulting formulation was applied on a metallic panel with a dry film thickness of 10 microns and rubbed with a solvent (MEK) until the metal appears. The MEK test results are summarized in Table 3.

### Example 20.b

24 g (0.013 eq carbamate) of acrylic resin of Example 17, 15 g of butyl glycol and 1.01 g (0.013 eq aldehyde) of a mixture of 1,3-cyclohexanedicarboxaldehyde and 1,4-cyclohexanedicarboxaldehyde (PARALOID™ EDGE XL-195) were mixed together. The resulting formulation was applied on a metallic panel with a dry film thickness of 10 microns. The MEK test results are summarized in Table 3.

### Example 20.c

19.2 g (0.011 eq urea) of acrylic resin of Example 18, 23 g of butyl glycol and 0.80 g (0.011 eq aldehyde) of a mixture of 1,3-cyclohexanedicarboxaldehyde and 1,4-cyclohexanedicarboxaldehyde (PARALOID™ EDGE XL-195) were mixed together. The resulting formulation was applied on a metallic panel with a dry film thickness of 10 microns. The MEK test results are summarized in Table 3.

TABLE 3

| Coating evaluation | | Example 20.a | Example 20.b | Example 20.c |
|---|---|---|---|---|
| Source of the Tested Resin | | Example 16 | Example 17 | Example 18 |
| Temperature | Duration | Solvent resistance (MEK double rubs) | | |
| Room Temperature | — | 45 | 10 | 35 |
| 50° C. | 10 minutes | 55 | 10 | 60 |
| 100° C. | 10 minutes | 120 | 30 | 55 |
| 150° C. | 10 minutes | >150 | 90 | 130 |
| 200° C. | 10 minutes | >200 | 120 | >200 |

### Example 21

### Evaluation of Coating of Example 19

5 g (0.008 eq acetal) of acrylic resin of Example 19, 7 g of butyl glycol and 0.3 g (0.004 eq urea) of glycoluril was mixed together. The resulting formulation was applied on a metallic panel with a dry film thickness of 10 microns. The MEK test results are summarized in Table 4.

TABLE 4

Tested Resin (Source):
Example 19

| | | Solvent resistance (MEK |
|---|---|---|
| Temperature | Duration | double rubs) |
| Room Temperature | — | 10 |
| 50° C. | 10 minutes | 10 |
| 100° C. | 10 minutes | 30 |
| 150° C. | 10 minutes | 90 |
| 200° C. | 10 minutes | >200 |
| Room temperature | — | 10 |

### Example 22

Comparative coating evaluation of Examples 11, 12, 13, and 14

### Example 22.a

2.45 g (0.01 eq acetal) of acrylic resin of example 11, 5 g of butyl acetate, and 18 g (0.01 eq urea) of a ureido methacrylate functionalized acrylic resin were mixed together. The ureido methacrylate functionalized acrylic resin used was synthesized in DOWANOL™ PM with a solid weight of 50%, with a urea equivalent weight on solid of 900.9, and with an acid value of 20.1. The resulting formulation, catalyzed with 1% of para toluene sulfonic acid, was applied on a metallic panel with a dry film thickness of 10 microns. The MEK test results are summarized in 10 Table 5.

TABLE 5

Tested Resin (Source):
Example 11

| | | Solvent resistance (MEK |
|---|---|---|
| Temperature | Duration | double rubs) |
| Room Temperature | — | 8 |
| 50° C. | 10 minutes | 40 |
| 100° C. | 10 minutes | 50 |
| 150° C. | 10 minutes | 70 |
| 200° C. | 10 minutes | 150 |

### Example 22.b

5 g (0.009 eq acetal) from Example 12, 8 g of butyl acetate, and 16.5 g (0.009 eq urea) of a ureido methacrylate functionalized acrylic resin were mixed together. The ureido methacrylate functionalized acrylic resin used was synthesized in DOWANOL™ PM with a solid weight of 50%, with a urea equivalent weight on solid of 900.9, and with an acid value of 20.1. The resulting formulation, catalyzed with 1% of para toluene sulfonic acid, was applied on a metallic panel with a dry film thickness of 10 microns. The MEK test results are summarized in TABLE 6.

TABLE 6

Tested Resin (Source):
Example 12

| | | Solvent resistance (MEK |
|---|---|---|
| Temperature | Duration | double rubs) |
| Room Temperature | — | 8 |
| 50° C. | 10 minutes | 40 |
| 100° C. | 10 minutes | 40 |
| 150° C. | 10 minutes | 50 |
| 200° C. | 10 minutes | 150 |

### Example 22.c

2.26 g (0.017 eq acetal) from Example 13, 16.71 g of DOWANOL™ PM, and 30 g (0.017 eq urea) of a ureido methacrylate functionalized acrylic resin were mixed together. The ureido methacrylate functionalized acrylic resin used was synthesized in DOWANOL™ PM with a solid weight of 50%, with a urea equivalent weight on solid of 900.9, and with an acid value of 20.1. The resulting formulation was applied on a metallic panel with a dry film 15 thickness of 8.5 microns. The MEK test results are summarized in Table 7.

TABLE 7

| | Tested Resin (Source): | | |
|---|---|---|---|
| | Example 13 | | |
| | | Solvent resistance | |
| | | (MEK double rubs) | |
| Temperature | Duration | After 1 Day | After 7 Days |
| Room Temperature | — | 6 | 33 |
| 50° C. | 10 minutes | 13 | 35 |
| 100° C. | 10 minutes | 40 | 65 |
| 150° C. | 10 minutes | 95 | 100 |
| 200° C. | 10 minutes | >200 | >200 |

### Example 21.d

4 g (0.014 eq acetal) from Example 14, 8 g of butyl acetate, and 24.8 g (0.014 eq urea) of a ureido methacrylate functionalized acrylic resin were mixed together. The ureido methacrylate functionalized acrylic resin used was synthesized in DOWANOL™ PM with a solid weight of 50%, with a urea equivalent weight on solid of 900.9, and with an acid value of 20.1. The resulting formulation, catalyzed with 1% of para toluene sulfonic acid, was applied on a metallic panel with a dry film thickness of 10 microns and the MEK test results are summarized in Table 8.

TABLE 8

Tested Resin (Source):
Example 14

| | | Solvent resistance |
|---|---|---|
| Temperature | Duration | (MEK double rubs) |
| Room Temperature | — | 2 |
| 50° C. | 10 minutes | 50 |
| 100° C. | 10 minutes | 55 |
| 150° C. | 10 minutes | 190 |
| 200° C. | 10 minutes | >200 |

### Example 23

### Furanic dialdehyde was synthesized from 5,5′-[oxybis(methylene)]di-(2-furaldehyde)

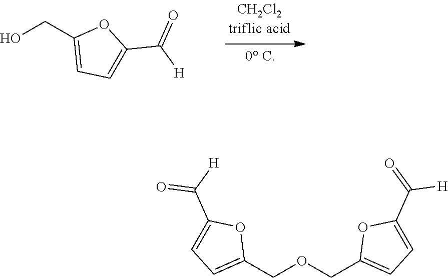 [SMILES: O=Cc1ccc(CO)o1 ; O=Cc1ccc(COCc2ccc(C=O)o2)o1]

10 g (0.079 moles) of hydroxymethyl furfural (HMF) and 100 ml of dichloromethane were loaded in a reaction vessel equipped with a condenser, a stirrer, and a temperature probe, and the mixture was stirred under an inert argon atmosphere. A mixture of 0.5 g trifluoromethanesulfonic acid (triflic acid) and 10 ml of dichloromethane was added dropwise to the reaction vessel at 0° C., maintaining the temperature at 0° C. during the addition. After completion of the reaction, the organic phase was washed with 100 ml water, followed by a second washing with 50 ml water. The resulting organic phase was dried on anhydrous sodium sulfate. After removal of solids via filtration, dichloromethane was removed by distillation, and the HMF was removed under vacuum. The resulting product was analyzed by ¹H-NMR. The spectrum showed that the product contained 5% residual HMF.

### Example 24

### Preparation of hydroxymethyl furfural (HMF) methacrylate monomers

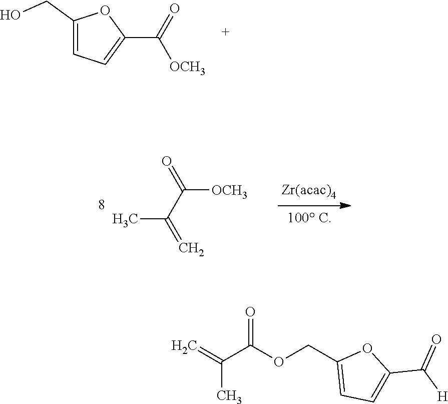

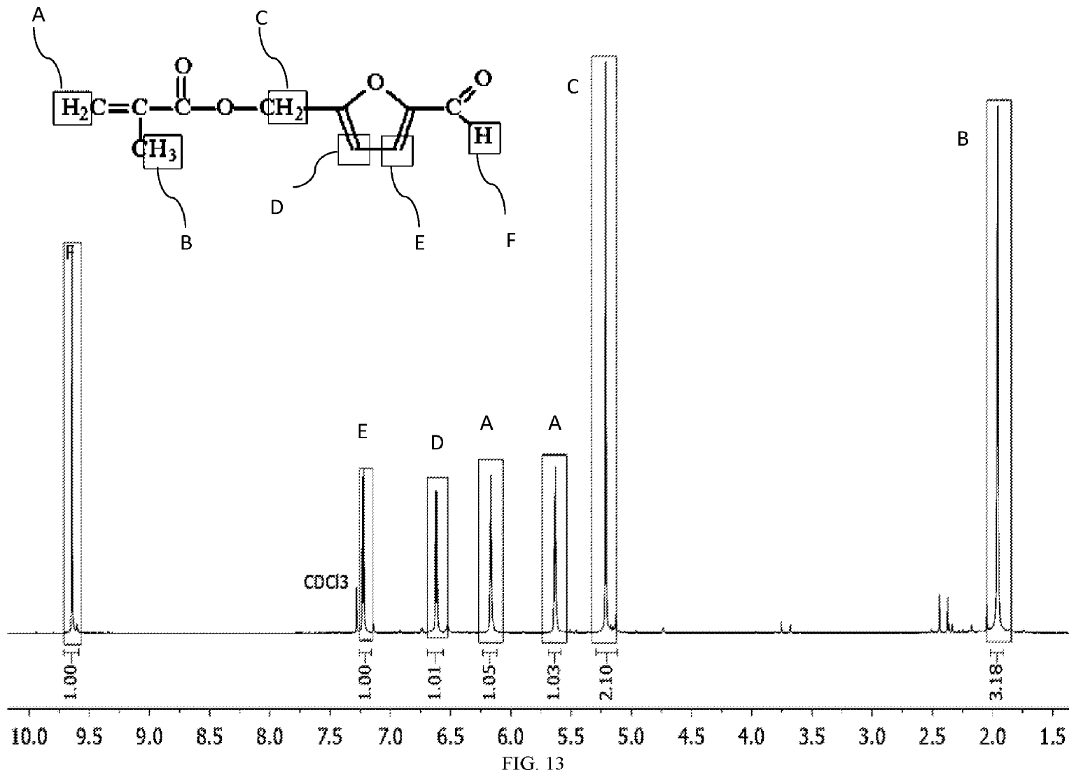

100 g (0.793 moles) of hydroxymethyl furfural (HMF), 635.1 g of methyl methacrylate, and 0.7 g (0.0032 moles) of hydroquinone were loaded into a reaction vessel equipped with a Dean-Stark receiver. The mixture was stirred at 100° C. for 30 minutes to remove water traces. 11.6 g of zirconium acetylacetonate was added to the reaction vessel and the reaction mixture stirred for 10 hours at 100° C. During this time the distillate containing the methanol from the Dean-Stark receiver was periodically removed. The reaction mixture was then distilled under vacuum at 10-2 mbar and 70° C. temperature to remove the methyl methacrylate. The product was redissolved in dichloromethane and washed 3 times with a potassium bicarbonate solution in water. After a last wash with a saturated brine solution in water, the organic phase was dried with anhydrous sodium sulphate. After filtration to remove solids, the solvent was distilled under vacuum at 10-2 mbar and 70° C. The reaction procedure as described furnished the product as a viscous brown liquid in 139 g (90%) yield. ¹H-NMR of the product helped characterize it as HMF methacrylate. The ¹H-NMR is shown in FIG. 13.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. It should be understood that this disclosure is not intended to be unduly limited by the illustrative embodiments and examples set forth herein and that such examples and embodiments are presented by way of example only with the scope of the disclosure intended to be limited only by the claims set forth here.

1. A coating system comprising:
a urea component;
an aldehyde comprising two or more carbon atoms; and
a solvent.

2. The coating system of claim 1, wherein the urea component is present at a molar ratio of 0.5 to 2.5 moles for every 1 mole of the aldehyde.

3. The coating system of claim 1, wherein the urea component is represented by Formula (I): 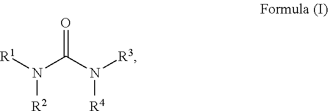
wherein R¹, R², R³, and R⁴ are independently H or a carbon-containing group, optionally further substituted with one or more oxygen, nitrogen, or sulfur atoms or a combination thereof, preferably where R¹, R², R³, and R⁴ are independently H or an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group,
wherein at least one of R¹, R², R³, and R⁴ is H, and
wherein any two of R¹, R², R³, and R⁴ may connect together to form a cyclic group.

4. The coating system of claim 1, wherein the urea component is part of an oligomer comprising a plurality of unsubstituted or substituted urea functional groups.

5. The coating system of claim 1, wherein the aldehyde is represented by Formula (II) or Formula (IIA): 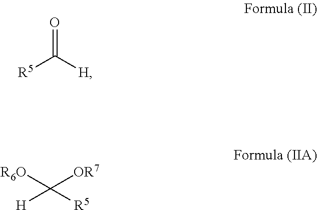
where R⁵, R⁶, and R⁷ are independently a carbon-containing group, optionally further substituted with one or more oxygen, nitrogen, or sulfur atoms or a combination thereof, preferably where R⁵, R⁶, and R⁷ are independently an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, optionally wherein the aldehyde is in a protected form comprising an acetal or a hydrate.

6-8. (canceled)

9. The coating system of claim 1, wherein the urea component and the aldehyde form a reaction product represented by Formula (III): 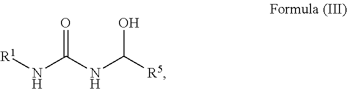
wherein R¹ is a carbon-containing group, optionally further substituted with one or more oxygen, nitrogen, or sulfur atoms or a combination thereof, preferably where R¹ is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, and R⁵ is as in Formula (II).

10. The coating system of claim 9, wherein the urea component and the aldehyde form a further reaction product represented by Formula (IV): 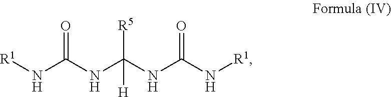
wherein R¹ is a carbon-containing group, optionally further substituted with one or more oxygen, nitrogen, or sulfur atoms or a combination thereof, preferably where R¹ is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, and R⁵ is as in Formula (II).

11. The coating system of claim 1, wherein the coating system is free or substantially free of formaldehyde and free or substantially free of isocyanate.

12. (canceled)

13. The coating system of claim 1, wherein the coating system is curable at a temperature of 60° C. or lower.

14. A coating system comprising a reaction product of:
a urea component; and
an aldehyde comprising two or more carbon atoms.

15. The coating system of claim 14, wherein the reaction product is a crosslinked product of Formula (III): 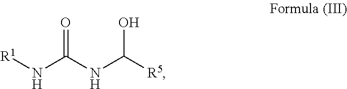
wherein R¹ is a carbon-containing group, optionally further substituted with one or more oxygen, nitrogen, or sulfur atoms or a combination thereof, preferably where R¹ is an alkyl, aryl, acyl, acrylate, carboxylic acid, urethane, ester, amide, carbonate, alkenyl, alkynyl, alkoxy, CROSSLINKABLE COATING SYSTEM AND COATINGS PREPARED FROM THE alcohol, amine, alkylamine, methacrylate, acrylamide, methacrylamide, vinyl, phenol, ketone, or urea group, and R⁵ is as in Formula (II).

16. The coating system of claim 1, wherein the reaction product is a crosslinked product of Formula (IV): 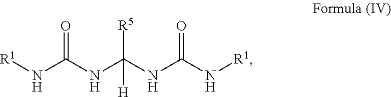
wherein R¹ is a carbon-containing group, optionally further substituted with one or more oxygen, nitrogen, or sulfur atoms or a combination thereof, preferably where R¹ is an alkyl, aryl, acyl, acrylate, carboxylic acid, urethane, ester, amide, carbonate, alkenyl, alkynyl, alkoxy, alcohol, amine, alkylamine, methacrylate, acrylamide, methacrylamide, vinyl, phenol, ketone, or urea group, and R⁵ is as in Formula (II).

17. (canceled)

18. (canceled)

19. The coating system of claim 14, wherein the coating system is free or substantially free of formaldehyde and structural units derived from formaldehyde, and free or substantially free of isocyanate and structural units derived from isocyanate.

20. (canceled)

21. The coating system of claim 5, wherein the coating system is provided as a one-part coating, and wherein the aldehyde comprises a protected aldehyde.

22. The coating system of claim 21, wherein the protected aldehyde comprises an acetal or a hydrate.

23. The coating system of claim 1, wherein the aldehyde is a protected aldehyde comprising an acetal or a hydrate.

24. The coating system of claim 7, wherein the aldehyde comprises a polyaldehyde chosen from the group consisting of terephthaldehyde, glutaraldehyde, glyoxal, dimethoxy acetaldehyde, methylglyoxal, cyclohexanedicarbaldehyde, malondialdehyde bis(dimethyl acetal), 5,5′-(oxy-bis(methylene))bis-2-furfural, bis(dimethyl acetal) of imidazolidone, tetra-dimethyl acetal of glycoluryl, bis(dimethyl acetal) of polyglycidyl ether, tri (aminoethyl dimethyl acetal) of itaconic, tri (aminoethyl dimethyl acetal) of TMPEOTA, or poly(dimethyl acetal) of polycyclocarbonate.

25. The coating system of claim 22, wherein the R⁶ and R⁷ groups on the acetal of Formula (IIA) are the same.

26. The coating system of claim 22, wherein the protected aldehyde comprises a cyclic acetal.

27. An article coated with the coating system of claim 1.
